(19) United States
(12) Patent Application Publication
(10) Pub. No.: US 2004/0018839 A1
(43) Pub. Date: Jan. 29, 2004

(54) Protocol and structure for mobile nodes in a self-organizing communication network

(76) Inventors: Oleg Andric, West Palm Beach, FL (US); Vernon Anthony Allen, Fort Lauderdale, FL (US); Lance Eric Hester, Sunrise, FL (US); Priscilla Chen, Palo Alto, CA (US); Yan Huang, Weston, FL (US)

Correspondence Address: LARSON + ASSOCIATES PC, 221 EAST CHURCH ST., FREDERICK, MD, 21701, US

(21) Appl. No.: 10/454,890

(22) Filed: Jun. 5, 2003

Related U.S. Application Data
(60) Provisional application No. 60/386,511, filed on Jun. 6, 2002.

(51) Int. Cl. H04Q 7/20

(52) U.S. Cl. 455/433; 455/435.1

(57) ABSTRACT

A self-organizing network characterized as having a number of nodes, with at least one control node of the nodes operable to control one or more of the formation, maintenance and message routing between nodes of the network, and operable to support the association, maintenance, deployment, and disassociation of one or more mobile nodes (MN) in the network (200, 300). The mobile nodes do not form part of the logical backbone of the network and thus may have a static address assigned to them to facilitate communications between regular, fixed nodes of the network and the mobile node in an efficient manner.

### PRIORITY DATA

This application claims the benefit under Title 35, United States Code Section 119(e), to U.S. provisional application serial No. 60/386,511 filed Jun. 6, 2002.

### CROSS REFERENCE TO RELATED APPLICATIONS

This application is related to the following copending applications entitled “Protocol and Structure for Self-Organizing Network” (Docket No. CMP3526J) and “A Protocol for a Self-Organizing Network Using a Logical Spanning Tree Backbone” (Docket No. CM03403J), which are herein incorporated by reference.

### FIELD OF THE INVENTION

This invention relates generally to the field of communication networks. More particularly, the invention relates to a protocol and structure for a self-organizing network operable to have mobile nodes.

### BACKGROUND

There are many applications for wireless communication networks, such as wireless sensors, industrial control and monitoring, intelligent agriculture, asset and inventory tracking, and security. The manual configuration of such networks can be time consuming and expensive. There is therefore a need for a communication protocol that produces an ad hoc, self-organizing network; that is, a network with a random topology in which the network organization and maintenance occur without human intervention. It would also be desirable that such a self-organizing network provide flexibility in the functionality and geographical location of the devices deployed within it in a manner that minimizes energy expenditure and utilization of available transmission bandwidth.

### BRIEF DESCRIPTION OF THE DRAWINGS

The novel features believed characteristic of the invention are set forth in the appended claims. The invention itself, however, as well as the preferred mode of use, and further objects and advantages thereof, will best be understood by reference to the following detailed description of an illustrative embodiment when read in conjunction with the accompanying drawing(s), wherein:

FIG. 1 is a diagrammatic representation of a cluster head selection process in accordance with,certain embodiments of the invention.

FIG. 2 is a diagrammatic representation of a link setup process between a cluster head and a member node in accordance with certain embodiments of the invention.

FIG. 3 is a diagrammatic representation of a single-hop cluster structure in accordance with certain embodiments of the invention.

FIG. 4 is a diagrammatic representation of a multi-hop cluster setup procedure in accordance with certain embodiments of the invention.

FIG. 5 is a diagrammatic representation of a multi-hop cluster structure in accordance with certain embodiments of the invention.

FIG. 6 is a diagrammatic representation of a process for updating a neighbor list in accordance with certain embodiments of the invention.

FIG. 7 is a diagrammatic representation of an exemplary network in accordance with certain embodiments of the invention.

FIG. 8 is a neighbor list of a node in cluster border of the network shown in FIG. 7.

FIG. 9 is a diagrammatic representation of an exemplary network in accordance with certain embodiments of the invention.

FIG. 10 is a link-state report corresponding to the network in FIG. 9.

FIG. 11 is a diagrammatic representation of an exemplary network in accordance with certain embodiments of the invention.

FIG. 12 is a topology update table corresponding to the network in FIG. 11.

FIG. 13 is a diagrammatic representation of an exemplary network with a failed node in accordance with certain embodiments of the invention.

FIG. 14 is a modified link-state report table for the network shown in FIG. 13.

FIG. 15 is a diagrammatic representation of the network in FIG. 13 following a first stage of link recovery.

FIG. 16 is a topology update table for the network shown in FIG. 15.

FIG. 17 is a diagrammatic representation of the network in FIG. 13 following a second stage of link recovery.

FIG. 18 is a link-state report table for the network shown in FIG. 17.

FIG. 19 is a topology update table for the network shown in FIG. 17.

FIG. 20 is a diagrammatic representation of multiple access control using RTS/CTS messages in accordance with certain embodiments of the invention.

FIG. 21 is a flow diagram showing data packet forwarding flow in accordance with certain embodiments of the invention.

FIG. 22 is an interaction diagram of a first example of cluster ID assignment in accordance with certain embodiments of the invention.

FIG. 23 is a diagrammatic representation of a network corresponding to FIG. 22.

FIG. 24 is an interaction diagram of a second example of cluster ID assignment.

FIG. 25 is a diagrammatic representation of a network corresponding to FIG. 24.

FIG. 26 is an interaction diagram of a third example of cluster ID assignment in accordance with certain embodiments of the invention.

FIG. 27 is a diagrammatic representation of a network corresponding to FIG. 26.

FIG. 28 is an interaction diagram of a fourth example of cluster ID assignment in accordance with certain embodiments of the invention.

FIG. 29 is a diagrammatic representation of a network corresponding to FIG. 28.

FIG. 30 is an interaction diagram of an exemplary network.

FIG. 31 is a network link-state report corresponding to the network shown in FIG. 30.

FIG. 32 is a diagrammatic representation of an exemplary network in accordance with certain embodiments of the invention.

FIG. 33 is a network topology update table corresponding to the network shown in FIG. 32.

FIG. 34 is a diagrammatic representation of an exemplary network illustrating network redundancy in accordance with certain embodiments of the invention.

FIG. 35 is a modified network link-state report corresponding to the network shown in FIG. 34.

FIG. 36 is a modified network topology update table corresponding to the network shown in FIG. 34.

FIG. 37 is a diagrammatic representation of an exemplary multi-cluster network illustrating border nodes in accordance with certain embodiments of the invention.

FIG. 38 shows the structure of an exemplary HELLO message in accordance with certain embodiments of the invention.

FIG. 39 shows the structure of an exemplary CONNECTION REQUEST message in accordance with certain embodiments of the invention.

FIG. 40 shows the structure of an exemplary CONNECTION RESPONSE message in accordance with certain embodiments of the invention.

FIG. 41 shows the structure of an exemplary NODE ID REQUEST message in accordance with certain embodiments of the invention.

FIG. 42 shows the structure of an exemplary NODE ID RESPONSE message in accordance with certain embodiments of the invention.

FIG. 43 shows the structure of an exemplary DISCONNECTION REQUEST message.

FIG. 44 shows the structure of an exemplary DISCONNECTION RESPONSE message in accordance with certain embodiments of the invention.

FIG. 45 shows the structure of an exemplary LINK-STATE REPORT message in accordance with certain embodiments of the invention.

FIG. 46 shows the structure of an exemplary TOPOLOGY UPDATE in accordance with certain embodiments of the invention.

FIG. 47 shows the structure of an exemplary NETWORK CONNECTION REQUEST message in accordance with certain embodiments of the invention.

FIG. 48 shows the structure of an exemplary NETWORK CONNECTION RESPONSE message in accordance with certain embodiments of the invention.

FIG. 49 shows the structure of an exemplary CLUSTER ID REQUEST message in accordance with certain embodiments of the invention.

FIG. 50 shows the structure of an exemplary CLUSTER ID RESPONSE message in accordance with certain embodiments of the invention.

FIG. 51 shows the structure of an exemplary NETWORK DISCONNECTION REQUEST message in accordance with certain embodiments of the invention.

FIG. 52 shows the structure of an exemplary NETWORK DISCONNECTION RESPONSE message in accordance with certain embodiments of the invention.

FIG. 53 shows the structure of an exemplary NETWORK LINK-STATE REPORT message in accordance with certain embodiments of the invention.

FIG. 54 shows the structure of an exemplary NETWORK TOPOLOGY UPDATE message in accordance with certain embodiments of the invention.

FIG. 55 shows the structure of an exemplary REQUEST TO SEND (RTS) message in accordance with certain embodiments of the invention.

FIG. 56 shows the structure of an exemplary CLEAR TO SEND (CTS) message in accordance with certain embodiments of the invention.

FIG. 57 shows the structure of an exemplary ACKNOWLEDGEMENT (ACK) for Intra Cluster Communication in accordance with certain embodiments of the invention.

FIG. 58 shows the structure of an exemplary ACKNOWLEDGEMENT (ACK) for Inter Cluster Communication in accordance with certain embodiments of the invention.

FIG. 59 shows the structure of an exemplary Intra Cluster DATA frame in accordance with certain embodiments of the invention.

FIG. 60 shows the structure of an exemplary Inter Cluster DATA frame in accordance with certain embodiments of the invention.

FIG. 61 illustrates an exemplary network with a variety of types of fixed, mobile, and control nodes in accordance with certain embodiments of the invention.

FIGS. 62-65 illustrate a number of exemplary connection scenarios that might be used by a mobile node in accordance with certain embodiments of the invention.

FIGS. 66-67 illustrate exemplary connection requests of a mobile node in accordance with certain embodiments of the invention.

FIG. 68 illustrates a flowchart of a method for association of a mobile node to a network in accordance with certain embodiments of the invention.

FIG. 69 is a network diagram illustrating movement of a mobile node in keeping with reassociation FIG. 68 illustrates a flowchart of a method for association of a mobile node to a network in accordance with certain embodiments of the invention.

FIG. 70 illustrates a flowchart of a method for reassociation of a mobile node to a network in accordance with certain embodiments of the invention.

FIGS. 71-74 are time lines representative of various modes of communication between a mobile node and its connecting node FIG. 68 illustrates a flowchart of a method for association of a mobile node to a network in accordance with certain embodiments of the invention.

FIG. 75 is a functional block diagram of a node of a network FIG. 68 illustrates a flowchart of a method for association of a mobile node to a network in accordance with certain embodiments of the invention.

### DETAILED DESCRIPTION

While this invention is susceptible of embodiment in many different forms, there is shown in the drawings and will herein be described in detail one or more specific embodiments, with the understanding that the present disclosure is to be considered as exemplary of the principles of the invention and not intended to limit the invention to the specific embodiments shown and described. In the description below, like reference numerals are used to describe the same, similar or corresponding parts in the several Views of the drawings.

Self-organizing network and associated routing protocols provide for the formation, maintenance and communications within one or more self-organizing networks, with such a communication network being characterized by a plurality of nodes in communication with at least one control node, charged with controlling one or more of the formation, maintenance and message routing between nodes of the network. Self-organizing communication networks may be wireless and wireless networks particularly lend themselves to the use of large numbers of low-power, low-cost nodes or communication devices. The nodes of the network thus often include a large number of network nodes (NN) or devices that do not move frequently, often being fixed, i.e. non-moving, nodes of the network. However, when they do move, their logical address information, i.e. position in the network relative to other nodes or devices of the network, can change as well. Other circumstances may cause their logical information to change as well, such as a node or link failure, since such occurrences would cause the hierarchical or logical position of the NN to change vis-á-vis the network.

The nodes of the network may additionally be mobile nodes-nodes free to change physical location within the network. Mobile nodes (MNs) may be subject to frequent physical and/or functional displacement into and out of the network, such as by being physically moved from one portion of a network to another, turned off, run out of battery back-up power, etc. In accordance with the present invention, mobile nodes, unlike NNs, do not change logical address information as they move around the network or come into (associate) and leave (disassociate) the network for a variety of reasons. They may thus retain their original logical information in their static address, which, as will be described, may be inherent to the MN in some form of the MN's MAC address or prescribed to it by the control node as a static network address.

The ability of the MN to retain its original logical information, in the form of a static address, is advantageous. Because MNs, as can also be the case with NNs, may be low-power, low-cost devices having limited memory and power capabilities, the amount of computation and control messaging that would otherwise be required to obtain new logical information may be appreciably reduced. This reduction in turn translates to immediate savings in battery life for the mobile node, as well as for NNs in proximity.

In addition to the above, a communication network having MNs or the ability to communicate with MNs is able to support various types of communications between MNs and other device/node types of the network. The use of a connecting, or proxy, node for a MN allows messages intended for the MN to be delivered by its connecting node. This applies whether the message is a multicast, broadcast, or unicast message having as its intended recipients both MNs and non-MNs or all MNs and is facilitated through the unique addressing associated with the MNs of the network.

A so-called cluster network is one approach to forming, maintaining, and supporting communications in a communication network having both NNs and MNs; it will be described at length below. It is understood that other types of self-organizing networks may be employed as well and are within the scope of the present invention. In addition to cluster network protocols, other protocols may rely upon logical backbone architectures, hierarchical tree structures, or other techniques to support data communications between the fixed network nodes.

Cluster Network Formation and Maintenance

The Cluster Tree Protocol is a protocol of the logical link and network layers for a wireless ad-hoc network. In one embodiment, the protocol uses link-state packets to form either a single cluster network, or a potentially larger cluster tree network. The network is basically self-organized, and supports network redundancy to attain a degree of fault resistance and self-repair.

Nodes select a cluster head and form a cluster according to the self-organized manner that will be described below. In the cluster formation process the cluster head assigns a unique node ID to each member node.

Self-developed clusters connect to each other using the Designated Device. The Designated Device is a special node that has high computing ability and large memory space; in some applications it is also the gateway between the network and the Internet. The Designated Device assigns a unique cluster ID to each cluster.

In an embodiment, a network is made of one or more clusters, each cluster having a cluster head and a number of member nodes. The formation and operation of a single cluster is described first. Multi-cluster networks are described later. Each node is directed by a computer program stored in a memory, an application specific integrated circuit, a digital signal processor or an equivalent device. Each node has an input for receiving data and an output for transmitting data.

Single Cluster Network: Cluster Formation Process

The Cluster formation process begins with the selection of the cluster head, the first node in the cluster. After a cluster head is selected, the cluster head expands links with other member nodes to form a cluster.

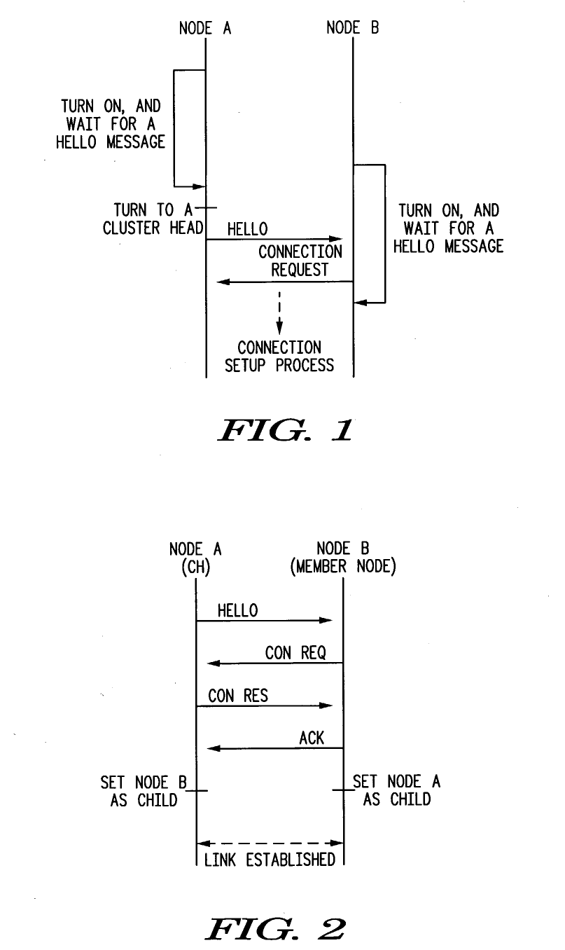

One example of selecting a cluster head is illustrated in FIG. 1. After a node turns on, it operates as a regular network node, and listens and searches for a HELLO message from other nodes. (A HELLO message is a simple broadcast message identifying the transmitting node.) If the node does not receive any HELLO messages for a first period of time, e.g., 1-30 seconds, it then operates as a cluster head and sends out a HELLO message to its neighbors. The new cluster head waits for responses from neighboring nodes for a second period of time, e.g., 2-60 seconds. If no connection requests are received, the node turns back to operation as a regular network node and listens again.

Other methods to select a cluster head are possible. The cluster head can be selected based on stored/calculated parameters of each node, like transmission range, power capacity, computing ability or location information. After a node is selected as a cluster head (CH), it broadcasts a periodic HELLO message that contains a part of the cluster head MAC (Multiple Access Control) address and a node ID (0 for example) that indicates the cluster head. This is shown in FIG. 2. Referring now to FIG. 2, the nodes that receive this HELLO message send a CONNECTION REQUEST message to the cluster head. When the cluster head receives the CONNECTION REQUEST, it responds to the node with a CONNECTION RESPONSE message that contains a node ID for the node. The node ID may be unique within a cluster and the cluster head has the responsibility to assign and manage unique node IDs to its member nodes. The node that is assigned a node ID replies with an ACK (acknowledge) message to the cluster head. After every message exchange is finished, both nodes set each other as parent or child. Each node maintains a neighbor list, which includes a list of parent and child nodes. Specifically, the cluster head denotes the newly added node as a child in its neighbor list and the new node denotes the cluster head as a parent. The link between the cluster head and the member node is established at this moment.

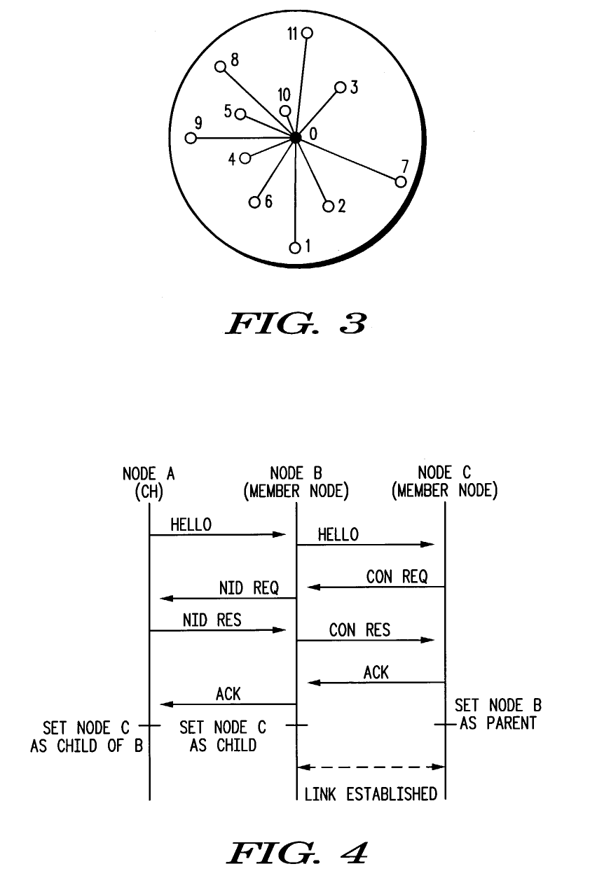

If all nodes are located in the range of the cluster head, the topology of connection becomes a star, as shown in FIG. 3, and every member node is connected to the cluster head with one hop. In an embodiment, the maximum number of nodes in a cluster is 254 including the cluster head. If node addresses with N-bits are used the maximum number of nodes is 2^{N}-2. The administrator or the manufacturer may limit the node feature to supporting only single hop cluster.

A cluster can expand into a multi-hop structure when each node supports multiple connections. Although network delay increases, the coverage within one cluster can increase. The multi hop cluster setup procedure is described in FIG. 4. After node B has established a link with the cluster head, it starts to relay HELLO messages from the cluster head. When node C gets the message from node B, it sends a CONNECTION REQUEST message to node B. Node B requests a new node ID to the cluster head for node C. When node B receives a new node ID from the cluster head, it sends a CONNECTION RESPONSE message to node C. Then node C receives it and answers with an ACK message. After this message exchange, node C sets node B as its parent, node B sets node C as its child, and the cluster head sets node C as node B's child. Node C then starts to relay HELLO messages to announce itself to its neighborhood.

When a node receives several HELLO messages from different nodes, there are many different ways to select the Hello message to which to respond. In accordance with certain embodiments, the node responds to the earliest HELLO message. In another embodiment, it responds to the strongest HELLO message. The path to the cluster head might not be ideal at this time. The route to the cluster head will optimize in a later process.

This expansion process can continue until the cluster head runs out of node IDs. The maximum hop count may also be limited to reduce maximum network delay.

When the cluster head has run out of node IDs or the cluster has reached some other defined limit, the cluster head should reject connection requests from new nodes. To reject the connection request, the temporary NID (NID 254 for example) is used in the destination NID field of the CONNECTION RESPONSE message or the new NID field of the NODE ID RESPONSE message.

When a requester node receives a NODE ID RESPONSE message with NID 254, it sends a CONNECTION RESPONSE message with NID 254 to the new node.

If a new node has received a CONNECTION RESPONSE with NID 254, it stores the cluster ID and stop sending a CONNECTION REQUEST message to the node belonging to the same cluster for a while.

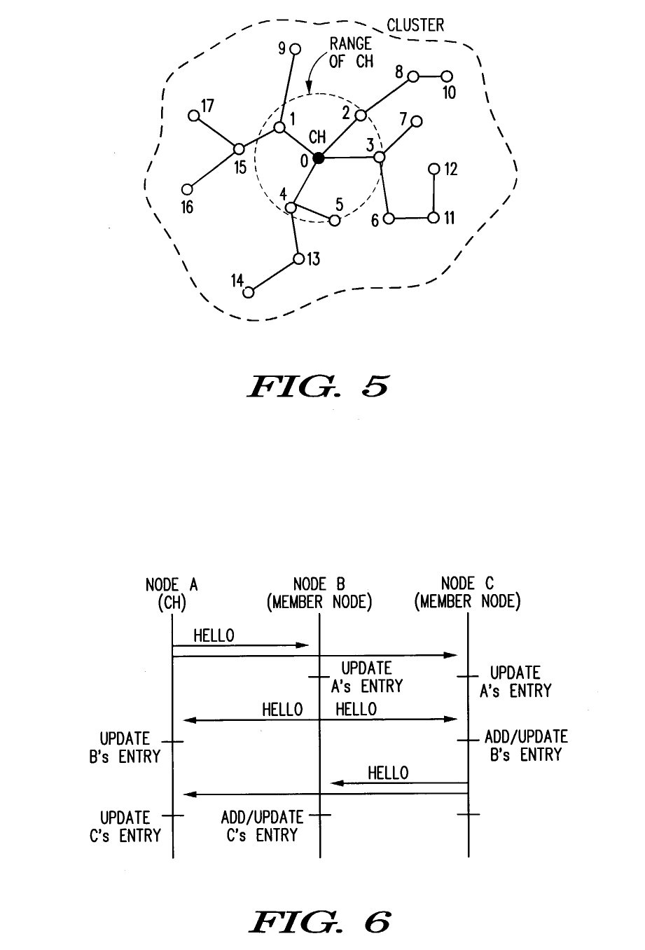

An example of a multi-hop cluster structure is shown in FIG. 5.

Single Cluster Network: Network Maintenance

The cluster head periodically broadcasts HELLO messages to its member nodes. When these member nodes receive the HELLO message from the cluster head, they also send HELLO messages to announce themselves to their neighbors. Every node records their neighbor nodes in their neighbor list. The entry of the neighbor list is updated by the periodic HELLO message. If a node entry doesn't update until certain timeout limit, it should be eliminated. This process is shown in FIG. 6.

The member nodes can talk directly with the neighbor nodes. If a node wants to communicate with a node outside of its range, it asks the cluster head or the parent node to relay the message to the destination.

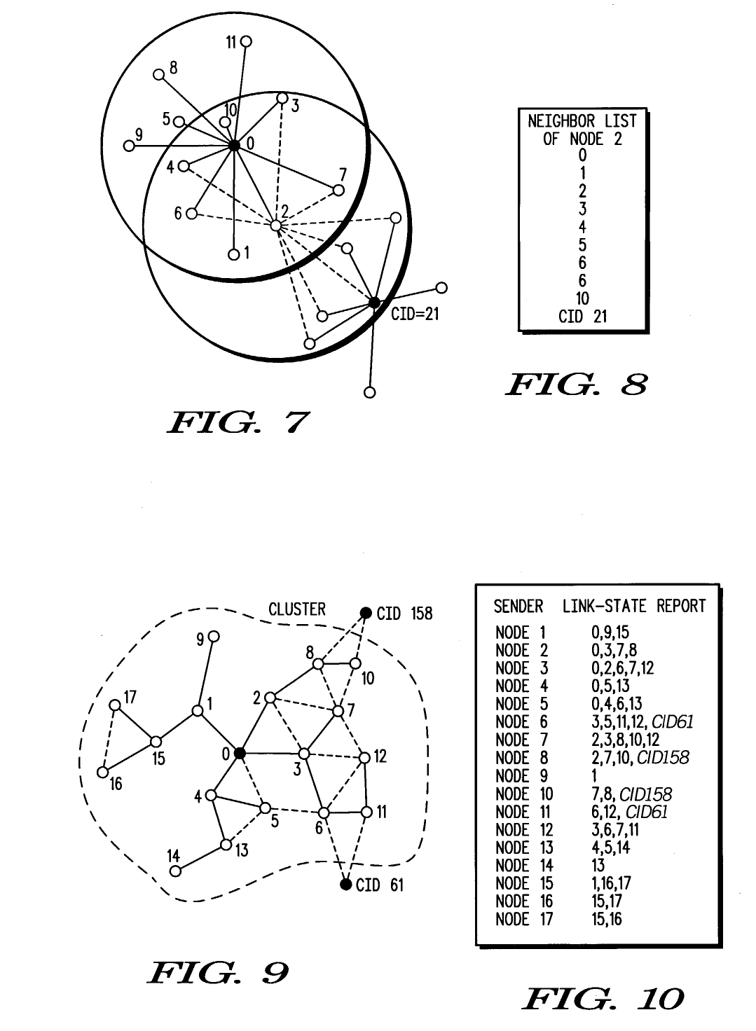

A node may receive a HELLO message from a node that belongs to different cluster. In that case, the node adds the cluster ID (CID) of the transmitting node in the neighbor list. An exemplary network is shown in FIG. 7. The corresponding neighbor list for node 2 is shown in FIG. 8.

Every node has to report its link state to the cluster head. A member node periodically sends a LINK-STATE REPORT message that contain its neighbors node ID list to the cluster head. The frequency of Link-State Report message will be determined by application requirements and stability. FIG. 9 shows an exemplary network. A table of the link-state reports sent by each node is shown in FIG. 10.

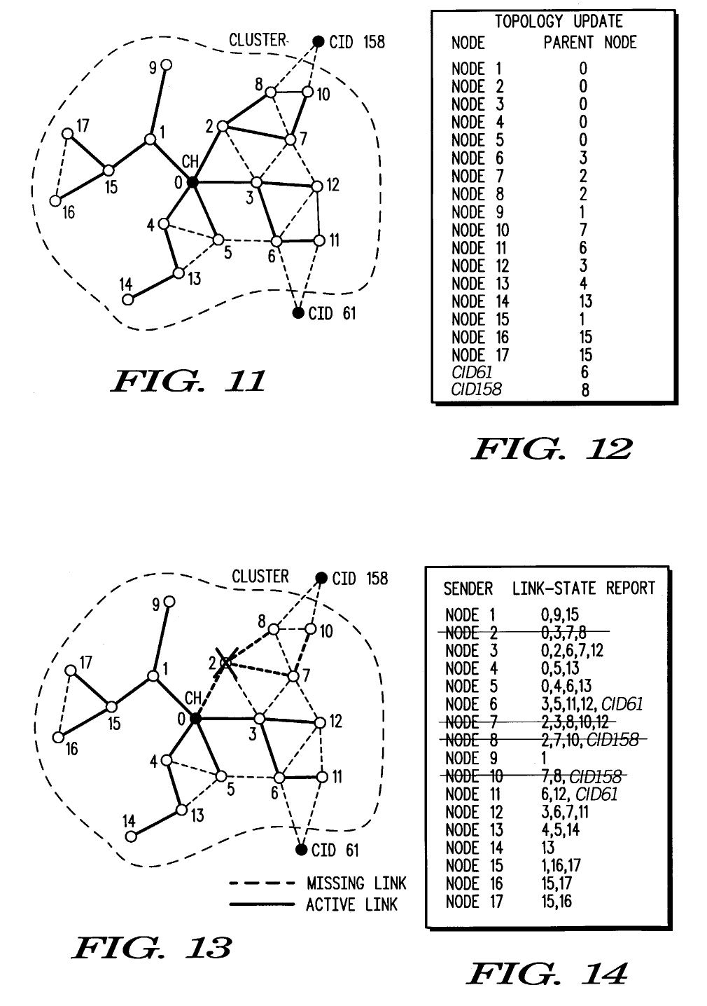

Based on the LINK-STATE REPORT message the cluster head periodically calculates the shortest path between itself and member nodes and informs it to the members by TOPOLOGY UPDATE message. An example of a TOPOLOGY UPDATE report for the network shown in FIG. 11 is shown in FIG. 12.

The cluster head should choose the route with the smallest hop count. If there are several routes with the same hop count, the cluster head should choose the route that has the smallest node ID as the parent node or some similar arbitration rule.

If a member node receives the TOPOLOGY UPDATE message that the different parent node is linked to the node, it changes the parent node as indicated in the message. The member node also records its child nodes and the nodes below it in the tree at this time. The nodes within a cluster basically communicate with other node through the parent node except the case where they communicate with their neighbor nodes directly. The cycle of the Topology Update depends on the Link-State Report cycle.

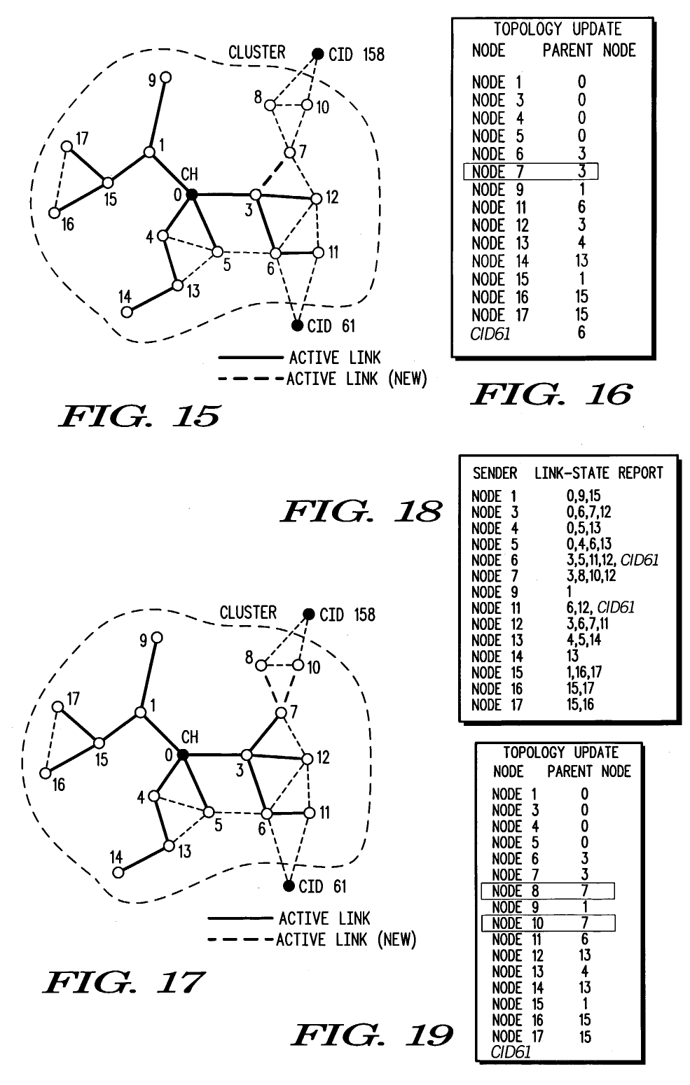

If a member node has trouble and becomes unable to communicate, the tree route of the cluster would be reconfigured. In the cluster shown in FIG. 13, the node 2 has trouble and stops communication. A modified table of corresponding link-state reports is shown in FIG. 14. Since the nodes 2, 7, 8 and 10 cannot send the LINK-STATE REPORT, the cluster head calculates a new route from other link-state information. By the first TOPOLOGY UPDATE message, the nodes 7 establishes a new connection with the nodes 3, as shown in FIG. 15. The corresponding topology update report is shown in FIG. 16. In the next cycle of TOPOLOGY REPORT and UPDATE, the nodes 8 and 10 are instructed to connect to nodes 7. The resulting network is shown in FIG. 17. The corresponding link-state report is shown in FIG. 18 and the corresponding topology update is shown in FIG. 19.

When the cluster head has trouble, the distribution of HELLO messages is stopped and all member nodes know that they have lost the cluster head. The member nodes lose their node ID and connections with the parent/children nodes. The cluster is then reconfigured in the same way as the cluster formation process.

Single Cluster Network: Intra Cluster Communication

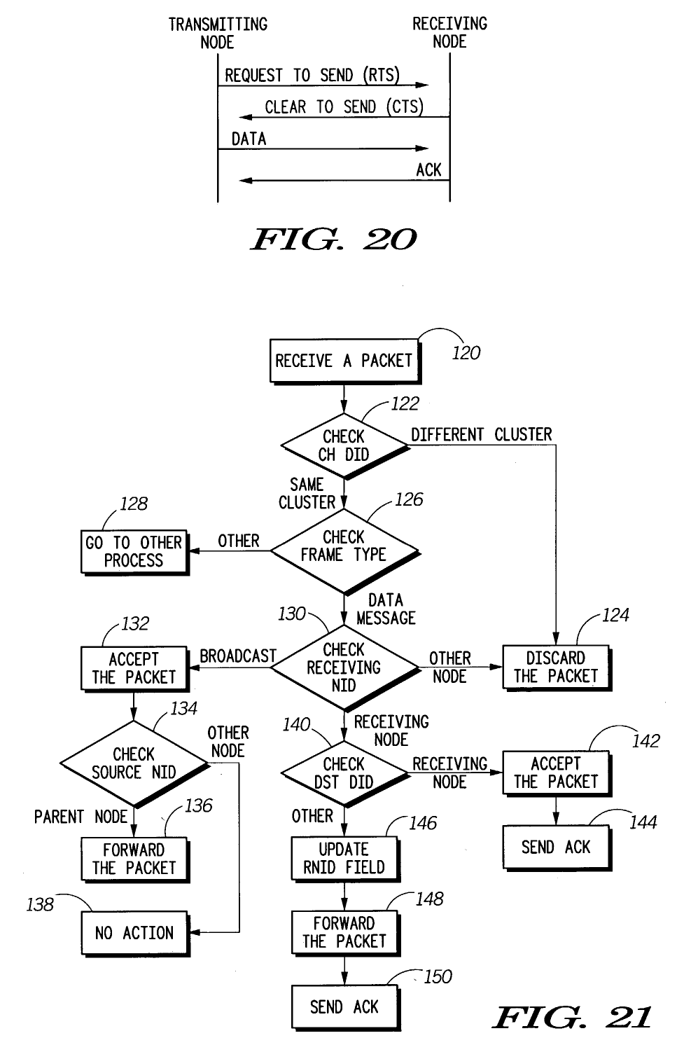

There are many options in Multiple Access Control. One is CSMA/CA (Carrier Sense Multiple Access/Collision Avoidance); another is pure ALOHA (where messages are sent at any time and then resent if the message is not received). In the CSMA/CA option, RTS (Request To Send)/CTS (Clear To Send) messages are used. Referring now to FIG. 20, when a node wants to send a packet to other node, it sends RTS at first and then waits for CTS. After receiving RTS, the receiving node sends a CTS frame to acknowledge the right for the sending node to send data frame. This procedure reduces the chance of collision by hidden nodes.

A node receiving an error-free frame can send an ACK frame to the sending node to acknowledge the successful reception of the frame.

When a node wants to send a packet to other node, i.e. it wants to unicast a message, it sets its node ID in the source NID field of the packet and its destination node ID in destination NID field. If a node isn't sending to one of its neighbors, and if the destination node is below the source in the tree, the source node sets its child node ID in the receiving NID field and asks its child node to forward to the destination. If the source isn't sending to one of its neighbors, and if the destination node isn't below the source branch, the source sets its parent node ID in the receiving NID field and sends the packet to its parent. Each intermediate node should relay the packet toward the destination node as it updates receiving and transmitting NID fields.

The packet is routed along the tree topology except for the last one hop. If the destination node is below the sender node in the tree structure, the packet is forwarded along the branch to the destination. Otherwise, the packet goes up along the tree structure and looks for the destination. If the intermediate node has the destination node in its neighbor list, the packet is routed apart from the tree route.

When a node receives a unicast message, the receiving node should respond to the transmitting node with an ACK message. The detail of packet forwarding process is described in FIG. 21. Referring to the flow chart in FIG. 21, the receiving node receives a packet at block 120. At decision block 122 a check is made to determine if the Cluster Head ID matches that of the cluster. If the Cluster Head ID is that of a different cluster, the packet is discarded at block 124. If the Cluster Head ID is that of the present cluster, flow continues to decision block 126. At decision block 126, the frame type is checked. If the frame type does not indicate that the packet contains data, the packet is passed to a different process at block 128. If the frame type indicates that the packet contains data, flow continues to decision block 130, where a check is made to determine if the Node ID is that of the present node. If the ID is that of another node, flow continues to block 124 and the packet is discarded. If the ID indicates that this is a broadcast message, flow continues to block 132 where the packet is accepted. At decision block 134 the Source Node ID is checked. If the source Node ID is that of the parent node, the packet is forwarded at block 136, otherwise no further action is taken, as indicated by block 138. Returning to decision block 130, if the receiving node ID is that of the receiving node, flow continues to decision block 140 and the Destination Device ID is checked. If the Destination Device ID matches the receiving node ID, the packet is accepted at block 142 and an acknowledgement (ACK) message is sent at block 144. If the Destination Device ID does not match the receiving node ID, the RNID field in the packet is updated at block 146, the packet is forwarded at block 148 and an ACK message is sent at block 150.

The broadcast message within a cluster is sent by the cluster head and forwarded by all member nodes. The receiving node shouldn't respond to the broadcast message with ACK message. A member node should forward the broadcast message that is sent by its parent to avoid forwarding the same packet more than once.

Large packets may be sent in several parts, in accordance with a packet fragmentation rule.

Inter Cluster Network

An embodiment of multi-cluster network formation and the subsequent communication between clusters is now described.

To form a multi-cluster network, a Designated Device is needed in the network. The Designated Device assumes an important role in the network. It has the responsibility to assign a unique cluster ID to each cluster head. This cluster ID, combined with the node ID that the cluster head assigns to each node within a cluster, forms a logical address and is used to route packets. Another role of the Designated Device is to calculate the shortest route from the cluster to Designated Device and inform it to all nodes within the network.

Inter Cluster Network: Network Formation Process

Each node is unique due to the combination of the cluster ID (CID) and the node ID (NID). The NID is assigned by each cluster head (CH) and the Designated Device (DD) assigns a unique CID to each cluster in early stage of multi-cluster network formation.

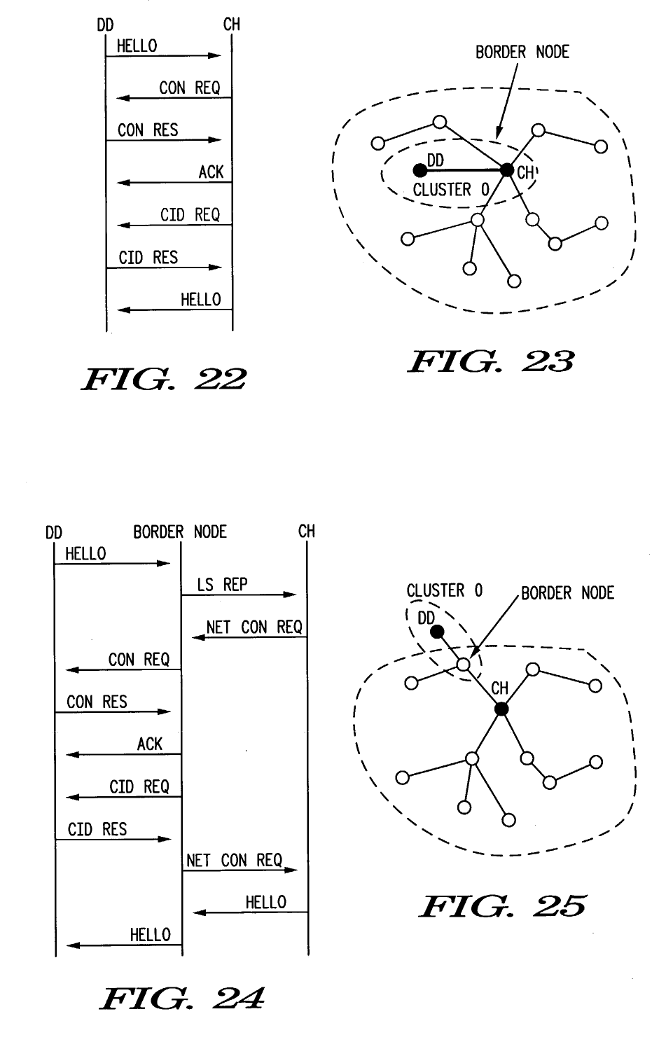

Referring now to the interaction diagram shown in FIG. 22, when the DD joins the network, it acts as the cluster head of cluster 0 and starts to send HELLO message to the neighborhood. If a CH has received this message, it sends a CONNECTION REQUEST message and joins the cluster 0. After that, the CH requests a CID to the DD. In this case, the CH is a border node that has two logical addresses. One is for a member node of the cluster 0 and the other is for a cluster head. When the CH gets a new CID, it informs to its member nodes by sending a HELLO message. The corresponding network is shown in FIG. 23.

Referring to FIG. 24, if a member node has received the HELLO message from the DD, it adds CID 0 in its neighbor list and reports to its CH. The reported CH selects the member node as a border node to its parent cluster and sends a NETWORK CONNECTION REQUEST message to the member node to set up a connection with the DD. The border node requests a connection and joins the cluster 0 as its member node. Then it sends a CID REQUEST message to the DD. After the CID RESPONSE message arrival, the border node sends a NETWORK CONNECTION RESPONSE message that contains a new CID to the CH. When the CH gets a new CID, it informs its member nodes by the HELLO message. The corresponding network is shown in FIG. 25.

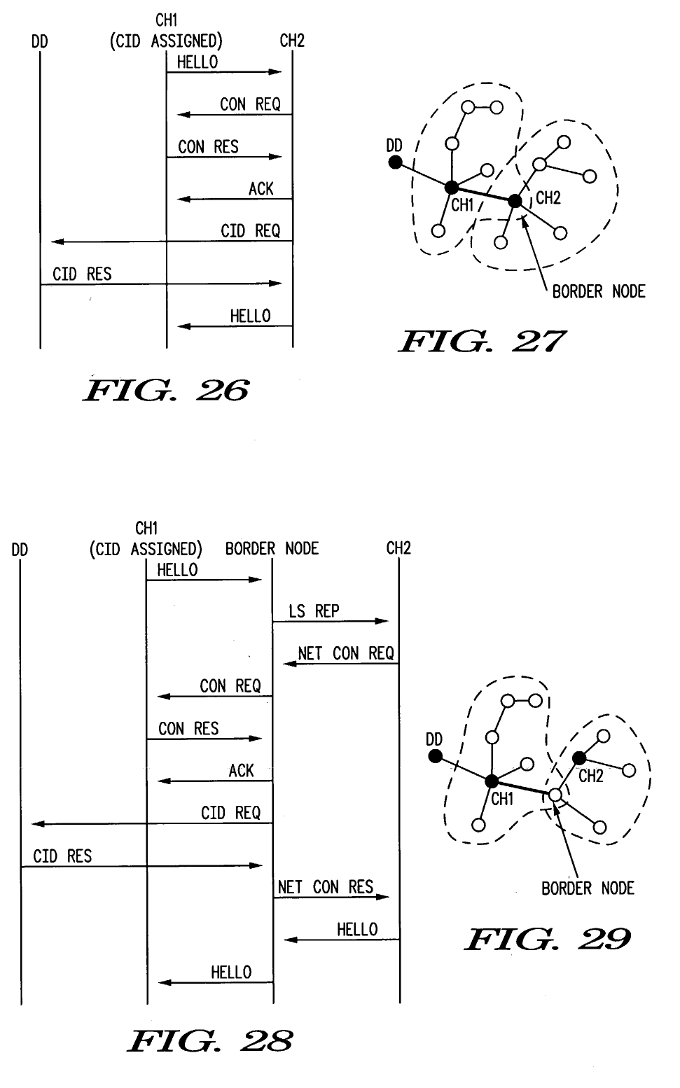

The clusters not bordering cluster 0 use intermediate clusters to get a CID. Two cases can be thought as the same as above. One case, shown in the interaction diagram in FIG. 26 and the network in FIG. 27, is where the CH becomes the border node to its parent cluster. The other case, shown in the interaction diagram of FIG. 28 and the corresponding network in FIG. 29, is where the CH names a member node as the border to its parent cluster. In both cases, the process is triggered by the HELLO message that contains a CID from 1 to 253 instead of the HELLO from the DD.

Each member node of the cluster records its parent cluster, child/lower clusters and the border node IDs associated with both the parent and child clusters. The DD stores the whole tree structure of the clusters.

Inter Cluster Network: Network Maintenance

Although the clusters form an initial tree topology in the CID assignment procedure, it may not be the optimal tree structure and the tree structure may change due to the failure of nodes. The clusters use the cluster link-state information to calculate the optimized route and periodically update their topology for the network redundancy.

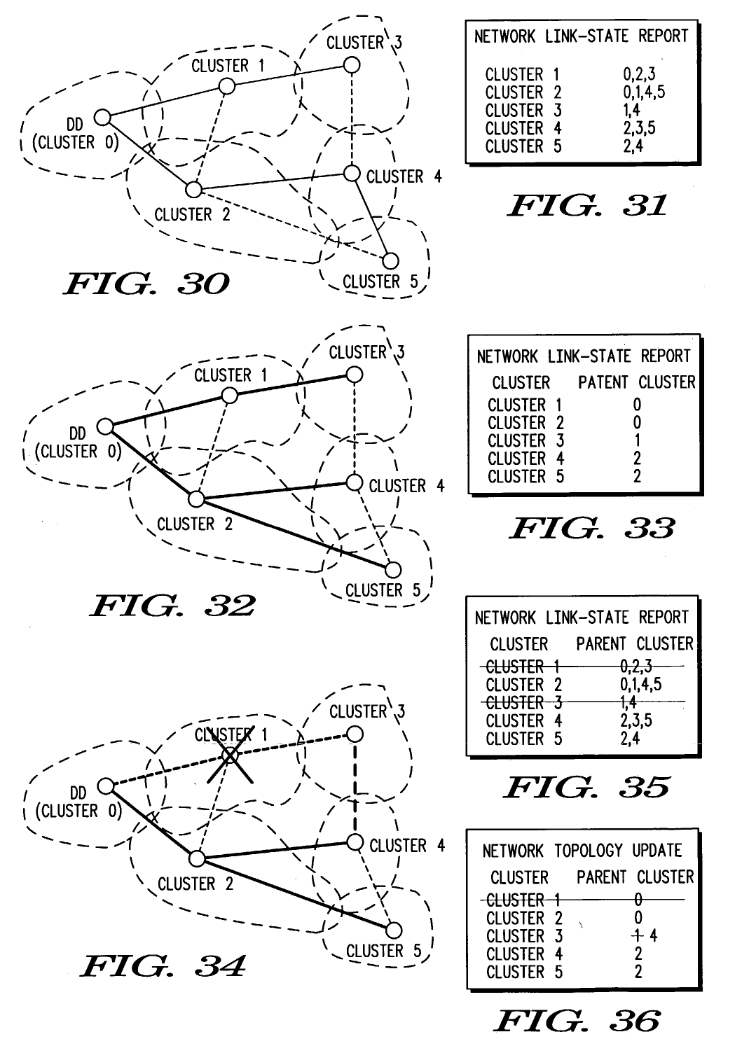

Every cluster reports its link-state information to the DD. The cluster head periodically sends a NETWORK LINK-STATE REPORT message that contains its neighbor cluster CID list to the DD. An exemplary network is shown in FIG. 30 and the corresponding link-state reports are shown in FIG. 31.

Based on the NETWORK LINK-STATE REPORT message, the DD periodically calculates the optimized tree route and sends a NETWORK TOPOLOGY UPDATE message to inform up-to-date route from the DD to the clusters. An exemplary network is shown in FIG. 32 and the corresponding network topology updates are shown in FIG. 33. The DD chooses the route with the smallest hop count. If there are several routes with the same hop count, the DD should choose the cluster that has the smallest CID as the parent cluster, or some other functional rule for arbitrating ties.

If a cluster head receives the NETWORK TOPOLOGY UPDATE message and determines that a different parent cluster is linked to the cluster, it changes the parent cluster as indicated in the message. All nodes within the cluster should memorize its parent cluster, child/lower clusters and the border nodes' NID at this time.

When a failure has occurred in the network, the cluster may have to find an alternative route to the DD. This feature is achieved by using the messages explained above.

In the example network shown in FIG. 34, a problem has occurred in cluster 1. The NETWORK LINK-STATE REPORT messages, shown in FIG. 35, from cluster 1 and 3 fail to arrive at the DD. The link-sate report from cluster 3 fails to arrive because it was linked to the DD via the failed cluster. The link-state report from cluster 2 no longer indicates a link to cluster 1. The DD broadcasts a new NETWORK TOPLOGY UPDATE message, shown in FIG. 36, and indicates cluster 3 to switch the parent to cluster 4.

A backup Designated Device (BDD) can be prepared to prevent network down time due to the DD's trouble. One example is that a BDD is connected to the DD by wired or wireless network and periodically duplicate the list of cluster ID and network link-state information from the DD. The BDD takes over the DD role as soon as it detects the DD's failure. Other solutions may be possible to realize the BDD.

Inter Cluster Communication

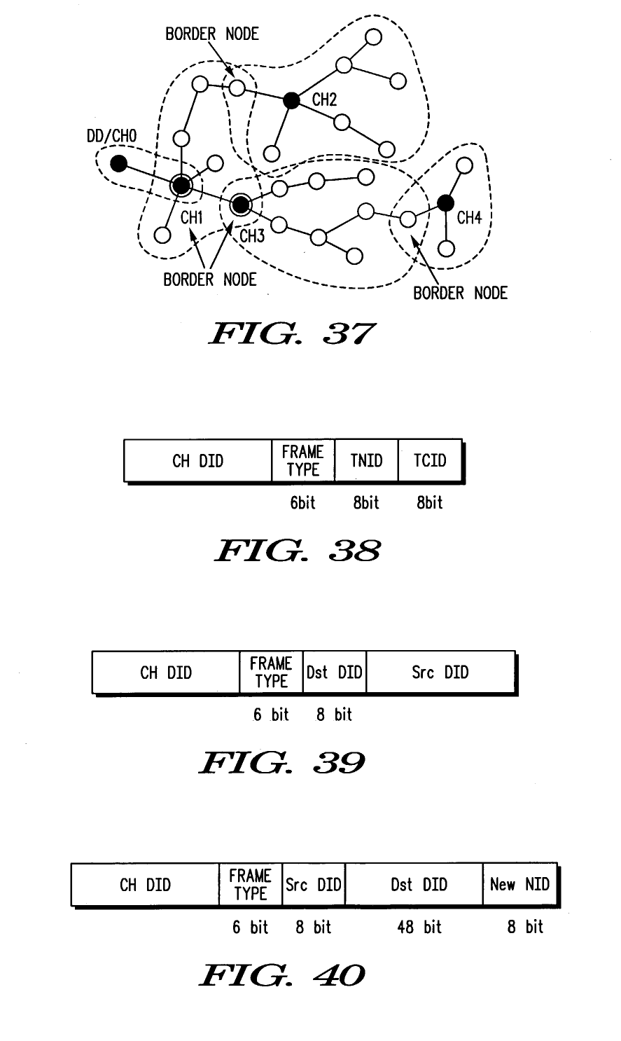

Inter cluster communication is realized by routing. The border nodes act as routers that connect clusters and relay packets between clusters. An exemplary multi-cluster network with border nodes is shown in FIG. 37.

Every node knows its parent cluster, child/lower cluster and the border node ID. When a node sends a unicast message (a message to a specific node), receiving nodes can decide where they should send/forward the packet. When a border node receives a packet, it examines the destination address, then forwards to the next border node in the adjacent cluster or to the destination node within the cluster.

Only the DD can broadcast a message by sending it to all nodes within its network. The message is forwarded along the tree route of clusters. The border node should forward the broadcast packet from the parent cluster to the child cluster.

An exemplary implementation of the network of the present invention is described in more detail below

Address Scheme

An exemplary address scheme is described below.

Each node is assigned a 16 bit logical address that consists of a cluster ID (CID) and a node ID (NID).

Cluster ID

The Designated Device assigns a unique 8-bit cluster ID to the cluster. CID 255 means all clusters and is used for broadcast message.

TABLE 1
Cluster ID

| Binary | Decimal | CID Function |
|---|---|---|
| 00000000 | 0 | Designated Device (DD) |
| 00000001 | 1 | Regular Cluster |
| \| | \| | |
| 11111101 | 253 | |
| 11111110 | 254 | Temporary Cluster ID |
| 11111111 | 255 | Broadcast |

Node ID

The cluster head assigns a unique 8-bit node ID to its member nodes. The cluster head uses NID 0. NID 255 is for broadcast and 254 for temporary use.

TABLE 2
Node ID

| Binary | Decimal | NID Function |
|---|---|---|
| 00000000 | 0 | Cluster Head (CH) |
| 00000001 | 1 | Member node |
| \| | \| | |
| 11111101 | 253 | |
| 11111110 | 254 | Temporary node ID |
| 11111111 | 255 | Broadcast |

Frame Structure

One embodiment of the different types of packets that are used for communication within and between clusters is described below.

Frame Type

A 6-bit field is defined for the frame type. The first two bits define the category of the function and the next four bits indicate the detail functions.

TABLE 3
Frame Type

| Frame Type | | |
|---|---|---|
| (bit 1, bit 2) | (bit 3, 4, 5, 6) | Frame Function |
| Intra Cluster | 0000 | HELLO |
| Management Frame | 0001 | CONNECTION |
| 00 | | REQUEST |
| | 0010 | CONNECTION |
| | | RESPONSE |
| | 0011 | NODE ID |
| | | REQUEST |
| | 0100 | NODE ID |
| | | RESPONSE |
| | 0101 | DISCONNECTION |
| | | REQUEST |
| | 0110 | DISCONNECTION |
| | | RESPONSE |
| | 0111 | LINK-STATE |
| | | REPORT |
| | 1000 | OPOLOGY |
| | | UPDATE |
| | 1001-1111 | Reserved |
| Inter Cluster | 0000 | NETWORK |
| Management Frame | | CONNECTION |
| 01 | | REQUEST |
| | 0001 | NETWORK |
| | | CONNECTION |
| | | RESPONSE |
| | 0010 | CLUSTER ID |
| | | REQUEST |
| | 0011 | CLUSTER ID |
| | | RESPONSE |
| | 0100 | NETWORK |
| | | DISCONNECTION |
| | | REQUEST |
| | 0101 | NETWORK |
| | | DISCONNECTION |
| | | RESPONSE |
| | 0110 | NETWORK |
| | | LINK-STATE |
| | | REPORT |
| | 0111 | NETWORK |
| | | TOPOLOGY |
| | | UPDATE |
| | 1000-1111 | Reserved |
| Control Frame | 0000 | REQUEST TO |
| 10 | | SEND (RTS) |
| | 0001 | CLEAR TO |
| | | SEND (CTS) |
| | 0010 | ACKNOWLEDGEMENT |
| | | (ACK) for Intra |
| | | Cluster |
| | 0011 | ACKNOWLEDGEMENT |
| | | (ACK) for Inter |
| | | Cluster |
| | 0100-1111 | Reserved |
| Data Frame | 0000 | INTRA CLUSTER |
| 11 | | DATA |
| | 0001 | INTRA CLUSTER |
| | | DATA with ACK |
| | 0010 | INTER CLUSTER |
| | | DATA |
| | 0011 | INTER CLUSTER |
| | | DATA with ACK |
| | 0100-1111 | Reserved |

Management Frames

Intra Cluster Management Frames

The structure of the HELLO message is shown in FIG. 38. Referring to FIG. 38, CH DID denotes the Cluster Head Device ID, which is a part of cluster head MAC address. This field is used to determine whether the transmitting node belongs to the same node cluster. TNID denotes the Transmitting Node ID: the node ID of source/intermediate node that sends the packet. TCID denotes the Transmitting Cluster ID, i.e. the cluster of transmitter. Before assignment of CID, the cluster head uses temporary CID 254.

The structure of the CONNECTION REQUEST message is shown in FIG. 39. Referring to FIG. 39, CH DID denotes the Cluster Head Device ID which is a part of the cluster head MAC address that the new node wants to join. Dst NID denotes the Destination Node ID, i.e. the node ID that the new node requests a connection and Src DID denotes the Source Device ID: a part of the source node MAC.

The structure of the CONNECTION RESPONSE message is shown in FIG. 40. Referring to FIG. 40, CH DID denotes the Cluster Head Device ID. Src NID denotes the Source Node ID, i.e. the node ID that is requested the connection by the new node. Dst DID is the Destination Device ID, and is a copy of Src DID field of CONNECTION REQUEST message. New NID denotes the New Node ID, which is the new node ID that is assigned to the requester node. When the requested node rejects the request, it puts 254 in this field.

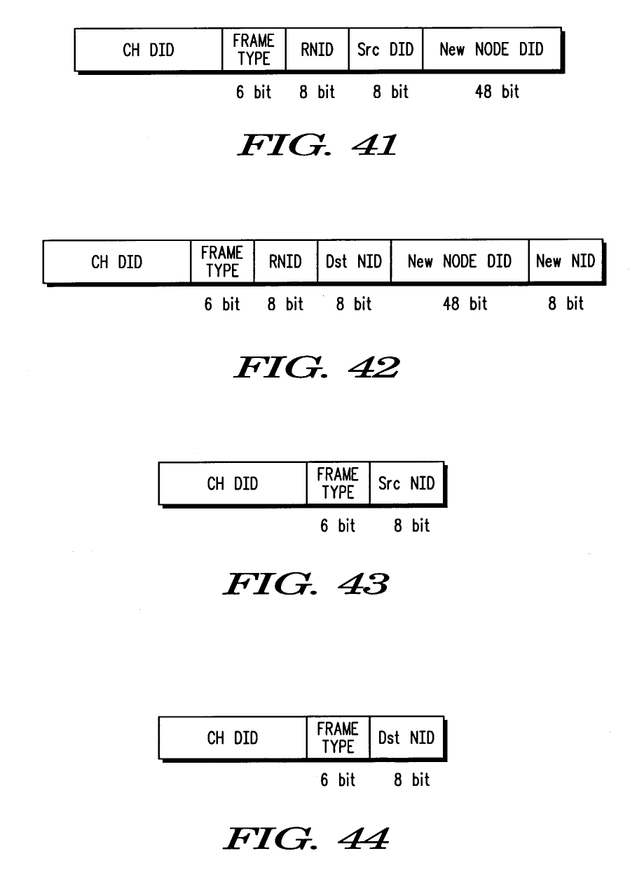

FIG. 41 shows the structure of the NODE ID REQUEST message. Referring to FIG. 41, CH DID denotes the Cluster Head Device ID and RNID denotes the Receiving Node ID, i.e. the node ID of destination/intermediate node that should receive the packet. Src NID denotes the Source Node ID, i.e. the node ID that is requesting the connection for the new node. New Node DID denotes the New Node Device ID. This is a copy of Src DID field of the CONNECTION REQUEST message

The structure of the NODE ID RESPONSE is shown in FIG. 42. Referring to FIG. 42, CH DID denotes the Cluster Head Device ID, RNID denotes the Receiving Node ID, Dst NID denotes the Destination Node ID and New Node DID denotes the New Node Device ID. The New Node DID is a copy of New Node DID field of the CLUSTER ID REQUEST message. New NID denotes the New Node ID, i.e. the node ID that is assigned to the new node. When the cluster head rejects the request, it puts the ID 254 in this field.

FIG. 43 shows the structure of the DISCONNECTION REQUEST message. Referring to FIG. 43, CH DID denotes the Cluster Head Device ID and Src NID denotes the Source Node ID (the node ID of requesting node).

FIG. 44 shows the structure of the DISCONNECTION RESPONSE message. Referring to FIG. 44, CH DID denotes the Cluster Head Device ID and Dst NID denotes the Destination Node ID.

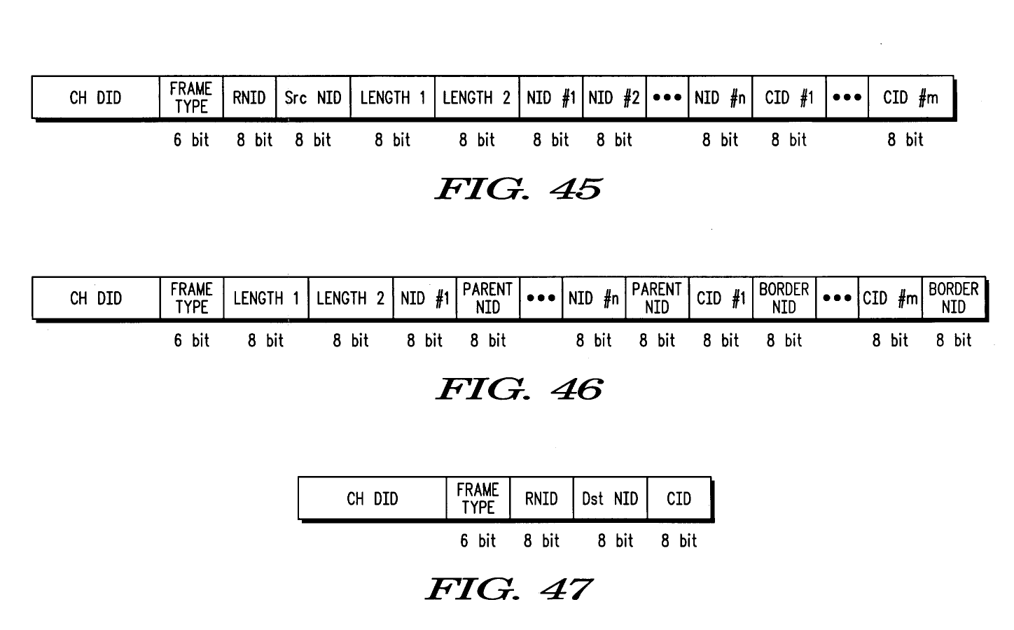

FIG. 45 shows the structure of the LINK-STATE REPORT message. Referring to FIG. 45, CH DID denotes the Cluster Head Device ID, RNID denotes the Receiving Node ID, and Src NID denotes the Source Node ID. Length 1 denotes the number of NID fields and Length 2 denotes the number of CID fields. NID #n is the identifier of neighbor node #n. CID #m is the identifier of neighbor cluster #m.

FIG. 46 shows the structure of the TOPOLOGY UPDATE message. Referring to FIG. 46, CH DID denotes the Cluster Head Device ID, Length 1 denotes the number of NID fields and Length 2 denotes the number of CID fields. NID #n is the identifier of member node #n. Parent NID is the Parent Node ID, that is the parent node ID for the member node #n named in the previous field. CID #m is the identifier for neighbor Cluster #m. Border NID is the Border Node ID: the border node ID for the cluster #in named in the previous field.

Inter Cluster Management Frames

FIG. 47 shows the structure of the NETWORK CONNECTION REQUEST message. Referring to FIG. 47, CH DID denotes the Cluster Head Device ID, RNID denotes the Receiving Node ID and Dst NID denotes the Destination Node ID. CID denotes the cluster ID that the border node should set up a connection with.

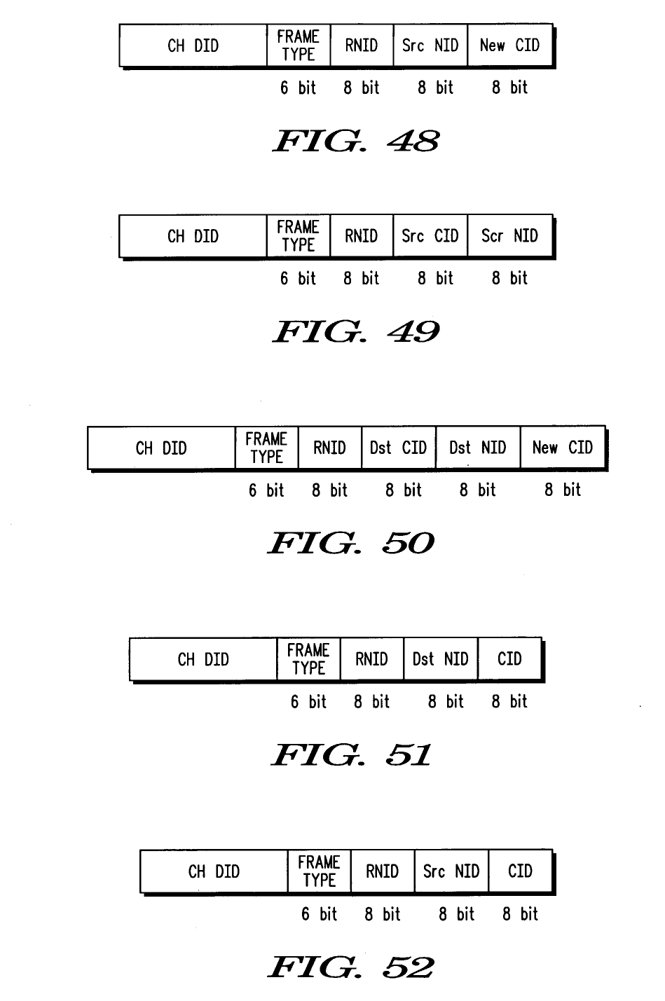

FIG. 48 shows the structure of the NETWORK CONNECTION RESPONSE message. Referring to FIG. 48, CH DID denotes the Cluster Head Device ID, RNID denotes the Receiving Node ID and Src NID is the Source Node ID, that is the node ID of the border node. New CID is the New Cluster ID that is assigned to the cluster head by the Designated Device.

FIG. 49 shows the structure of the CLUSTER ID REQUEST message. Referring to FIG. 49, CH DID denotes the Cluster Head Device ID, RNID is the Receiving Node ID and Src CID is the Source Cluster ID, that is the cluster ID of the border node. Src NID is the Source Node ID.

FIG. 50 shows the structure of the CLUSTER ID RESPONSE message. Referring to FIG. 50, CH DID denotes the Cluster Head Device ID. RNID denotes the Receiving Node ID, that is the node ID of destination/intermediate node that should receive the packet. Dst CID is the Destination Cluster ID, i.e. the cluster ID of the border node that requested a new CID. Dst NID is the Destination Node ID, i.e. the node ID of the border node that requested a new CID. New CID is the New Cluster ID that is assigned by the Designated Device.

FIG. 51 shows the structure of the NETWORK DISCONNECTION REQUEST message. Referring to FIG. 51, CH DID denotes the Cluster Head Device ID. RNID denotes the Receiving Node ID and Dst NID denotes the Destination Node ID. CID is the cluster ID that the border node should disconnect.

FIG. 52 shows the structure of the NETWORK DISCONNECTION RESPONSE message. Referring to FIG. 52, CH DID denotes the Cluster Head Device ID, RNID denotes the Receiving Node ID, Src NID denotes the Source Node ID and CID denotes the cluster ID that the border node has disconnected with.

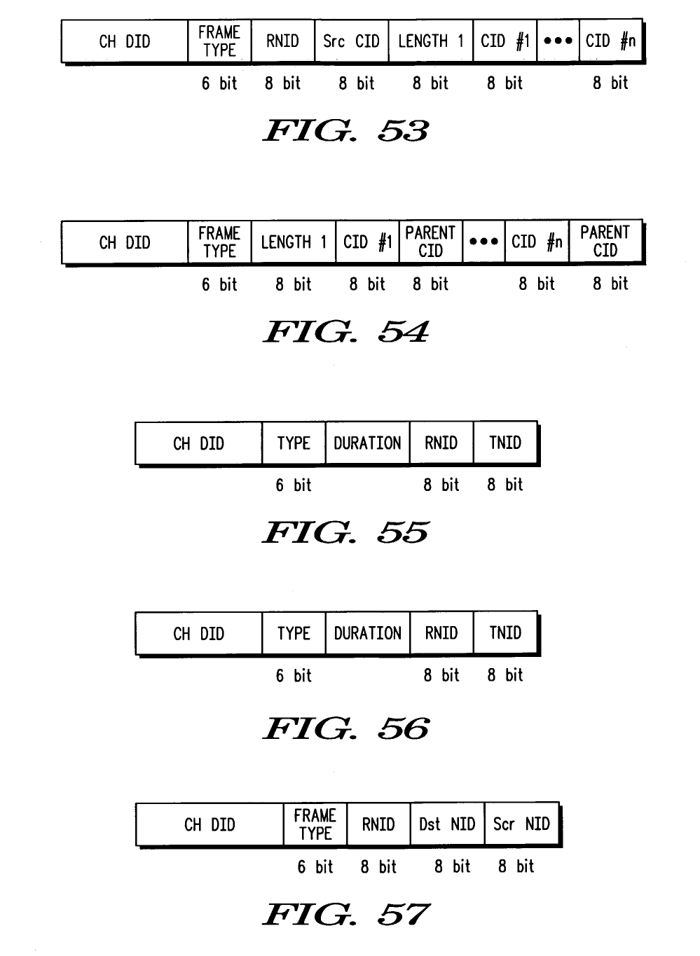

FIG. 53 shows the structure of the NETWORK LINK-STATE REPORT message. Referring to FIG. 53, CH DID denotes the Cluster Head Device ID, RNID denotes the Receiving Node ID and Src NID denotes the Source Node ID. Length 1 denotes the number of fields for CIDs and CID #n denotes the identifier of the neighbor cluster.

FIG. 54 shows the structure of the NETWORK TOPOLOGY UPDATE message. Referring to FIG. 54, CH DID denotes the Cluster Head Device ID, Length 1 denotes the number of fields for CIDs and their Parent CIDs. CID #n denotes the identifier of the cluster ID that exists in the network. Parent CID is the Parent Cluster ID for the cluster #n named in previous field. Control Frames

FIG. 55 shows the structure of the RTS message. Referring to FIG. 55, CH DID denotes the Cluster Head Device ID. The value of the Duration field is the amount of time the sending node needs to transmit the data frame, one CTS frame, one ACK frame and three inter-frame space intervals. RNID denotes the Receiving Node ID and TNID denotes the Transmitting Node ID.

FIG. 56 shows the structure of the CTS message. Referring to FIG. 56, CH DID denotes the Cluster Head Device ID. Duration is the duration of previous RTS frame minus the time required to transmit the CTS frame and an inter-frame space interval. RNID denotes the Receiving Node ID and TNID denotes the Transmitting Node ID.

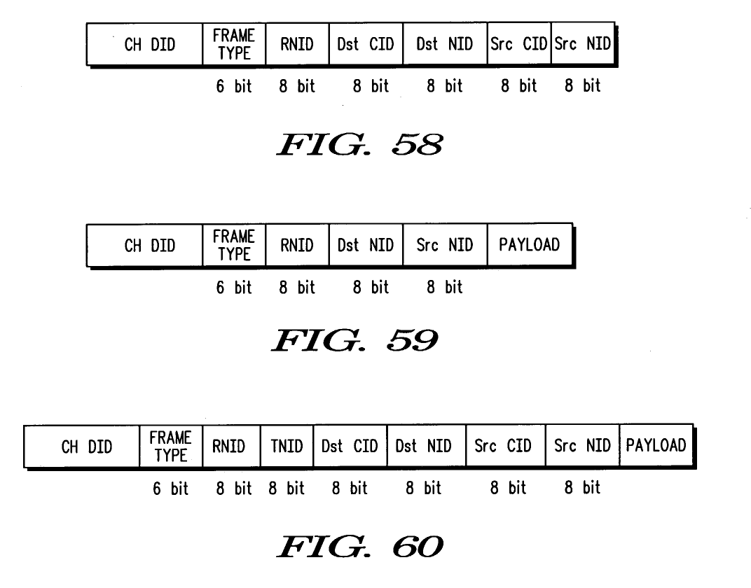

FIG. 57 shows the structure of the ACK message for Intra Cluster Communication. Referring to FIG. 57, CH DID denotes the Cluster Head Device ID and RNID denotes Receiving Node ID, that is the node ID of destination/intermediate node that should receive the packet. Dst NID denotes the Destination Node ID and Src NID denotes the Source Node ID.

FIG. 58 shows the structure of the ACK message for Inter Cluster Communication. Referring to FIG. 58, CH DID denotes Cluster Head Device ID, RNID denotes the Receiving Node ID, Dst CID denotes the Destination Cluster ID.and Dst NID denotes the Destination Node ID. Src CID denotes Source Cluster ID and Src NID denotes the Source Node ID.

Data Frames

FIG. 59 shows the structure of an Intra Cluster Data Frame. CH DID denotes the Cluster Head Device ID, RNID denotes the Receiving Node ID (the node ID of destination/intermediate node that should receive the packet) and Dst NID denotes the Destination Node ID. Src NID is the Source Node ID and Payload denotes the Data itself.

The Intra Cluster Data Frame with ACK has the same frame structure as Intra Cluster Data Frame except the Frame Type field.

FIG. 60 shows an Inter Cluster Data Frame. Referring to FIG. 60, CH DID denotes the Cluster Head Device ID, RNID denotes the Receiving Node ID (the node ID of destination/intermediate node that should receive the packet), Dst CID denotes the Destination Cluster ID and Dst NID denotes the node ID of the destination node. Src CID denotes the node ID of the source node, Src NID denotes the Source Node ID and Payload denotes the Data itself.

The Inter Cluster Data Frame with ACK has the same frame structure as Inter Cluster Data Frame except the Frame Type field.

Mobile Nodes in Communication Networks

Association and Disassociation/Relocation of Mobile Nodes

Mobile nodes (MNs) joining a network having a number of relatively stationary (fixed) nodes in communication with at least one control node, where the network may or may not be a cluster network as just described, need not go through the network joining procedure requisite for NNs. This is because the logical information of a MN, unlike a NN, is not dependent upon the hierarchical or logical position of the MN within the network. MNs are not part of the hierarchical tree network and are not used to route information to other nodes of the network. It is thus not practicable to have MNs obtain new logical network identifiers in the network as they associate with the network or change their geographical position in the network (through disassociating and subsequently re-associating themselves in the network). MNs are instead assigned a “static address”, a device-specific identifier that may stay with the MN, even as it changes geographical position in the network.

MNs are connected to the network through a conduit or proxy node, referred to as a connecting node. The connecting node is a regular node, such as a NN or a control node, through which the MN gains access to the logical backbone of the network. Many different types of nodes of a network may serve as a connecting node for one or more MNs; among the different types of logical device types that may be used in a communication network capable of supporting MN operation are gateway nodes, a network coordinator node, cluster head nodes, and network nodes. While logical nodes of these types may be used, they are not all required. A network within the meaning of the present invention includes a network having a number of NNs and at least one control node, to which one or more MNs are interested in joining, leaving, moving around in, etc. A gateway node, sometimes referred to as a root, is a device that is generally more capable than a typical low power, low cost network node or device, having interfaces to resources necessary to store databases of all the nodes in the network and perform relative location calculations; it may additionally have interfaces to external power sources if needed and to external high-speed networks, e.g. Ethernet LAN. The logical tree structures of the network may start at the gateway nodes. The network coordinator node operates as the central repository for the entire network and is responsible for address assignment of other gateway nodes and cluster head nodes in the network; one of the gateway nodes in the network will assume or be assigned the role of network coordinator (NC). Like the gateway node, the NC will have processing capabilities and have access to external computing and memory resources, such as through the use of a Microprocessor coupled to external processors and memory via a network interface. Gateway and NC nodes may of course have some amount of local memory and computing resources on-node as well. Network nodes (NNs) are the low cost, low power, primarily stationary, nodes characteristic of most of the nodes of the network. NNs are placed throughout the environment and autonomously form tree structures in accordance with the self-organizing abilities described above. Cluster head nodes are NNs assigned by the NC to be the root of new tree structures. This allows the network to cover wider areas with a limited number of gateway nodes. Mobile nodes, unlike NNs, are expected to move within the network, potentially on a regular basis. Although the network does not support continuous mobile communication in the form of handoffs, etc., MNs can connect (associate) and disconnect (disassociate) from the network on a regular basis. The location of these nodes may also be “tracked” by the network. MNs, NNs, and Cluster head nodes have processing abilities, such as might be provided by a microprocessor in communication with a number of sensors capable of sensing characteristics of the environments. The processing and computing capabilities of all the types of nodes enables the method of the present invention to be carried out by computer instructions (software, firmware, etc.) executed by general or specific purpose computers.

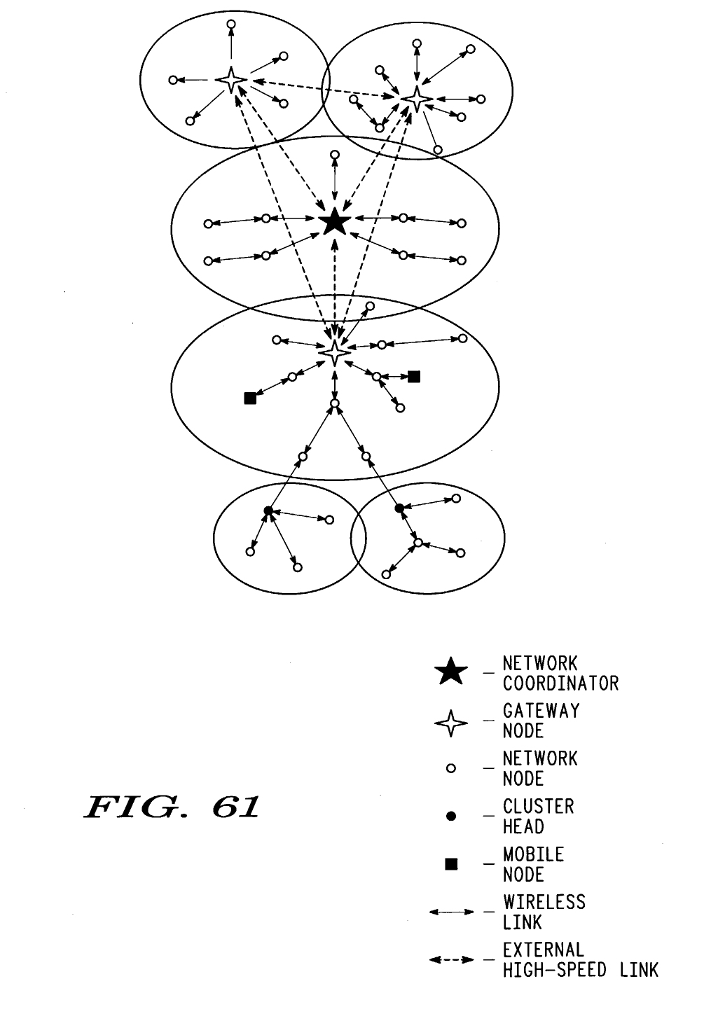

FIG. 61 illustrates an exemplary network having several different cluster configurations, delineated by circles. It can be seen that the network will have at least one control node; in this example, there are several different control nodes within the tree hierarchy, including two cluster heads, denoted by a small, dark circle; three different gateway nodes, denoted as a modified cross, and a network coordinator node denoted by the star symbol. For purposes of the discussion, the control node may be one or more of these different types of control nodes, or some functional combination thereof, the control node being capable of managing the joining, maintenance, leaving, movement, and message trafficking associated with having MNs in the network. In this sense, the control node may be representative of a control functionality. In the case where the MN wishes a control node to directly serve as its connecting node, the control functionality of updating the network to know to send messages intended to the MN in care of the control node will be accomplished by the control node.

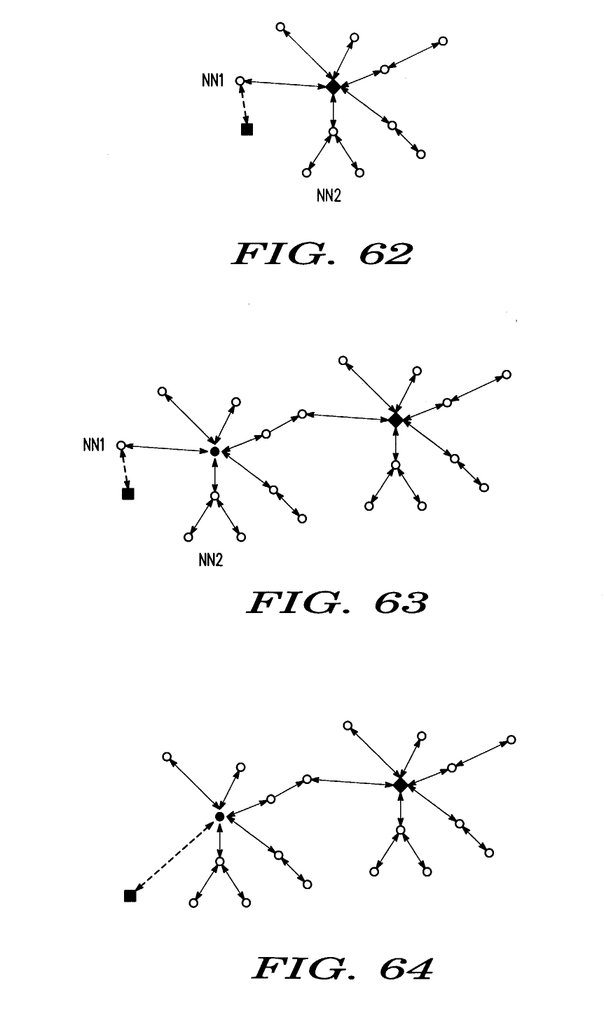

NNs are denoted by open circles and MNs are shown as black boxes. In the hierarchy, it can be seen that a cluster head of a cluster may communicate, via NNs to a gateway node, which, in turn, is coupled to a network coordinator node. Gateway nodes may communicate with other gateway nodes or directly with the network coordinator, both of which are illustrated. Cluster heads, gateway nodes, and network coordinator nodes are all examples of control nodes for purposes of this invention, and in FIGS. 62-65 are shown as a black diamond. In this example, mobile nodes are shown in communication with NNs; as illustrated in FIGS. 62-65, however, MNs may also be coupled to other network devices, so long as they are not other MNs.

Referring now to FIG. 62, a network having a number of NNs, including NN1 and NN2, a mobile node MN, and a control node (denoted by the black diamond). The MN has coupled to (connected to) NN1, which in turn is coupled to a control node, another node of the network having control functionality, such as a cluster head node, a gateway node, or a network coordinator, capable of managing the association, disassociation, and maintenance of MNs in the network. A control node may thus have processing and memory capabilities. NN1 operates as the connecting node for the MN node.

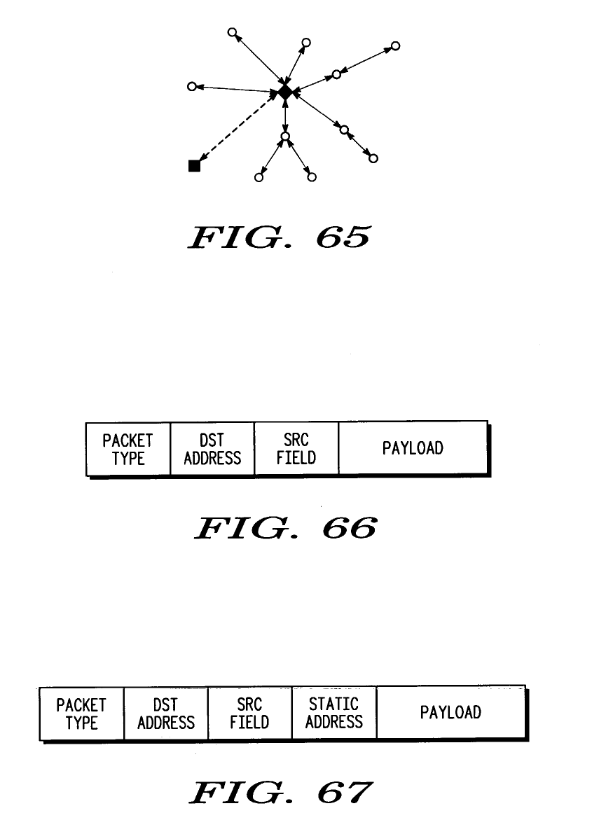

In FIG. 63, a MN is shown coupled to NN1, which is turn is coupled to a cluster head. NN1 is the connecting node for the MN. The cluster head is in communication with a control node via two NNs. As previously discussed, the control node in this configuration could be another cluster head, a gateway node, or a network coordinator node. In FIG. 64, the MN is shown in direct communication with a cluster head node, bypassing connection to a NN. The cluster head node operates as the connecting node for the MN in this instance. The cluster head, in turn, is coupled to a control node, such as another cluster head, a gateway node, or a network coordinator node. In FIG. 65, the MN is directly connected to a control node, such as a cluster head, a gateway node, or a network coordinator. In this instance, MN makes connection to a control node without an intervening NN connection.

Now that the types of network configurations to which a MN may join or be part of has been explored, the actual process for a MN joining a network, referred to as association, will be discussed. The MN is not part of the hierarchical tree network and thus does not participate in the routing of messages in the network, instead joining simply to send and receive messages. It does not, therefore, have a changeable logical address associated with it, only a static address to identify it; it is not practicable to have MNs obtain new logical network identifiers as they move throughout the network. The MN thus need not follow the network joining procedure utilized by other node types, described above.

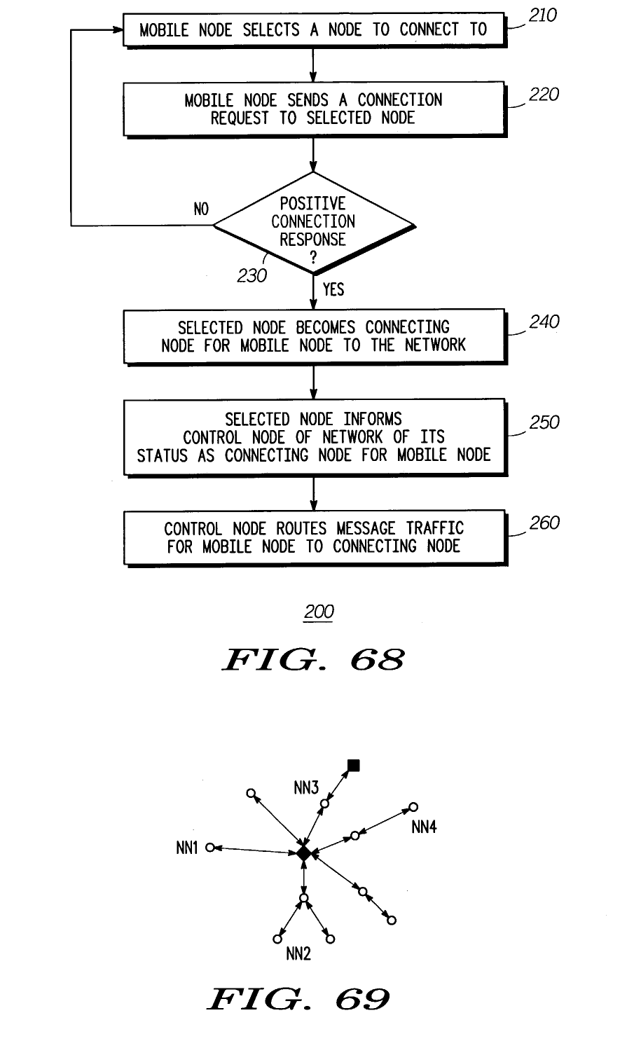

FIG. 68 illustrates a flowchart 200 of the process of association of a MN to a network; FIGS. 66-67 illustrate the types of connection requests that may be put forth by the MN in the process of attempting to join or re-join a network. In block 210, the MN selects a node that will behave as its connecting node to the network. As illustrated in FIGS. 62-65, the MN may select almost any type of node, including a control node, to be its connecting node, but cannot select another MN to perform this function. There may be any number of criteria used to determine which non-MN the MN will select as its connecting node from among several possible candidates in proximity to it. These criteria may include, by way of example and not limitation, the following: received signal strength measurements of the candidate non-MN nodes; the logic position in the tree hierarchy of the network of each of the various candidate non-MNs (i.e. how close the node is to the root of the hierarchy); the physical proximity of a candidate non-MN node to the MN, perhaps determined using global positioning system (GPS) technology; and the perceived ability of a node to service the MN in the manner and for the time required, including the energy reserves of the node, how many nodes are connected to the selected node, and the traffic history of the node.

The “static address” of the MN will need to be communicated to the control node of the network. As will be explained, depending upon how the static address is set, this operation may be started when the static address is communicated by the MN in its connection request to the selected node.

Appropriate address assignments are paramount to effective message delivery in a logical tree network structure. Because mobile nodes use static addressing, such that their address may not be explicitly visible within the logical tree, routing data packets to and from the MNs may be accomplished in a different manner than packets that are distributed among fixed nodes of the network tree. MNs take advantage of “proxy addressing” or “in care of addressing” in which messages intended for a MN are routed to the MN via its connecting node using the logical address of the associated connecting node. The connecting node's logical network address is explicitly marked in the relayed message's addressing fields, although implicitly the MN is the true originator or recipient of the message; the connecting node thus plays a proxy role for the MN it serves. Communications between the MN and its connecting node need to be maintained to ensure that the MN is able to timely receive messages and send them out via the connecting node. All messages within the network are routed only through non-MN nodes only and not through MNs.

As previously mentioned, it is not practicable to have MNs obtain new logical network identifiers as they move throughout the network. MNs instead have a “static” address to identify them that need not change as the MN changes geographical location within the network. Depending upon the application and the number of mobile devices involved, MNs obtain their static addresses in various ways. A static address of a MN may be assigned by a control node of the network, such as by the NC, referred to as a network static address of the MN, or it may be their pre-programmed IEEE address, such as a 64-bit IEEE address, referred to as a MN static address of the MN. In the case where the MN's unique MAC physical address is employed, the size of the address may vary, with 96-bits, 64-bits, 48-bits, etc. being representative sizes. Or the MN static address may be the MN's MAC address truncated to a 16-bit address or alternately to an 8-bit address with a unique 8 bit CID set aside for mobile devices/nodes in particular. In the case of the control node, such as the root or cluster head node, assigning a network static address, the control node may chose from a pool of addresses set aside in the network for MNs. For example, the 8-bit CID may be 253, reserved for mobile devices, and the 8-bit NID may be 0-255. Alternately, the network static address may just be a randomly chosen ID, such as a 16-bit ID, in which case the 8-bit CID may be 0-253, with 254 and 255 reserved for other functions, and the 8-bit NID may be 0-255.

Referring now to block 220 of FIG. 68, a MN sends a connection request to the selected node. As shown in FIG. 66, the connection request of a MN is much simpler than the connection request of a NN shown previously in FIG. 39. The packet type, destination address of the selected node, source field, and payload are fields communicated by the MN to the selected node. The selected node's address is explicitly marked in the relayed message's addressing fields, although implicitly the MN is the true originator or recipient of the message. In the source field, the MN may communicate connection status information about itself, such as whether it is a MN that has never joined, a MN that is re-joining (re-associating) itself with the network, etc. The field may comprise a code corresponding to the appropriate status of the MN. In the case of a MN that is re-associating with the network, this may convey that a static address needs to be assigned to the MN if a control node is responsible for assigning static addresses to MNs of the network. Optionally, the connection request may be a query for additional information needed by the MN to make a decision about whether the node would make a good connecting node for the MN.

Depending upon how the static addressing of the MN is determined, the connection request may or may not contain the static address of the MN. For instance, if the static address of the MN is its inherent, pre-programmed MAC address given to it by the node manufacturer or some variation of it, such as a truncated portion of the MAC address, then this MN static address is communicated to the targeted node in the communication request. Such is the case shown in FIG. 67, in which the static address is a field communicated by the MN to its selected node during the connection request; the static address may be contained in the payload field of the connection request message and designates that the message is associated with a MN and specifies the MN's static address. The static address may be the physical MAC address of the device itself, an inherent identifier that never changes, regardless of where the MN moves in the network; additionally, the static address could be a variation of the physical MAC address, such as a truncation of the address.

As a result of the connection request sent to the node the MN would like to be its connecting node, the selected node sends a response. At Decision block 230, if the connection response is positive, meaning that the node agrees to serve as the connecting node, the flow continues to block 240 where the selected node becomes connecting node for the MN. At block 250, the connecting node informs the control node, which may be the cluster head node, the gateway node, the network coordinator node, or other node capable of routing all the data traffic intended for MN to its connecting node, depending upon the relationship of the MN and its connecting node to the network. The control node must be aware of the connecting node's new status so that all messages to the MN are sent by proxy to the connecting node in the future, at block 260. If the response to the connection response is negative at Decision Block 230, then flow returns to block 210 for the MN to select another candidate to send a connection request to.

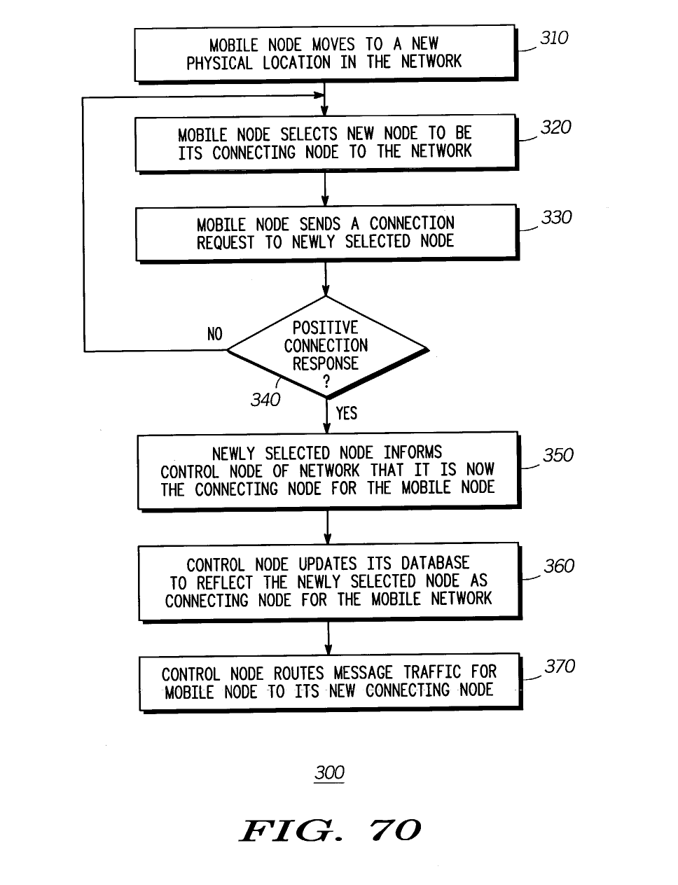

Once a MN has joined the network, it may physically move within the network, prompting it to disassociate itself and establish communications with another connecting node. Referring now to FIG. 69, it can be seen that the MN has moved and is no longer in close proximity to NN1, instead being closer to NN3 and NN4. In this case, the MN has selected NN3 as its connecting node and is in communication with it is as shown.

When a MN is displaced, it may retain its static address, but the displacement may necessitate relinquishing its existing connecting node in favor of a new connecting node. As a direct consequence of selecting a new connecting node, the connecting node via initiation by the MN through a transmitted reassociation connection request will update the network of the new association of the MN and itself. This will insure that all data messages for the MN will be addressed “in care of” the new connecting node and will be routed accordingly through the new connecting node. Even in the situation where the MN has changed its geographical position relative to the network, the network is able to “find it” and route messages to it in care of the new connecting node. Of course, it is possible for the MN to reassociate with the network with the same connecting node, in which case it is not required that the MN change geographical position.

Flowchart 300 of FIG. 70 illustrates an embodiment that occurs upon the MN moving locations within the network. At block 310, the MN moves to a new physical location, as in the case of MN moving from NN1 to proximity to NN3. The MN selects a new node, in the example, NN3, to be its connecting node at block 320 and sends out a connection request to NN3 at block 330. As previously discussed, the connection request may contain the MAC address or other MN static address inherent to the MN. Displacement or geographical movement of the MN within the network does not affect the static address of the MN in this instance. In the case where the control node assigns a network static address to the MN, the MN may retain this network static address as long as it did not leave the network and the connection request may thus contain the network static address previously assigned to the MN by the control node. In the case of the static address being a network static address assigned by the control node, upon the MN leaving the network, the network static address may be reclaimed by the network control node upon disassociation by the MN and made available to other MNs in subsequent need of a network static address. A MN may be considered to “leave” the network when it becomes incapable of communication with its connecting node, the occurrence of a disassociation event. Examples of disassociation events indicative of the inability of the MN to communicate with the network include, but are not limited to, the MN physically leaving the network, having a dead battery, an RF interferer in the vicinity of the MN, being turned off, or the MN not sending a beacon reply to a poll message from its connecting node, for instance. The determination of a MN leaving the network may be made upon the occurrence of certain conditions, such as after polling and learning that the MN is incapable of communications or after a predetermined period of silence from the MN. The way in which the MN communicates with the network will be discussed more later. A MN may also be considered to leave a network if it is longer in communication with the network by virtue of having physically moved out of range.

Referring back to FIG. 70, at Decision block 340, the inquiry is whether the selected node, NN3 in the example, has agreed to be the connecting node of the MN. If no, then the flow returns to block 320 so that the MN can find another candidate for connecting node. If yes, then at block 350, the connecting node informs the appropriate control node of its status as connecting node for the MN, prompting the control node to update its database to reflect the now correct proxy address for messages meant for the MN at block 360. This allows the control node to route the message traffic intended for the mobile node to its proxy, the connecting node at block 370.

Upon the MN actively deciding to disassociate from the network, it may optionally send a disassociation message to its connecting node to alert it to the impending disassociation, thereby allowing the connecting node to inform the control node, which can update appropriate network tables to prevent the control node from routing messages for the MN from a defunct connecting node. The MN's disassociation message may additionally tell the connecting node to resume its normal device operation, such as its normal sensing function in the case of a NN.

As MNs disconnect and re-attach to the network, they may not be “handed off” as they move, meaning that the network may not support a so-called “roaming” operation. In this instance, they may have to stop before re-accessing the network. Moreover, the network may not support the continuous tracking of fast moving MNs, in which case MN location may be updated when the MN stops moving or when the MN is moving relatively slowly, such as at less than walking speed.

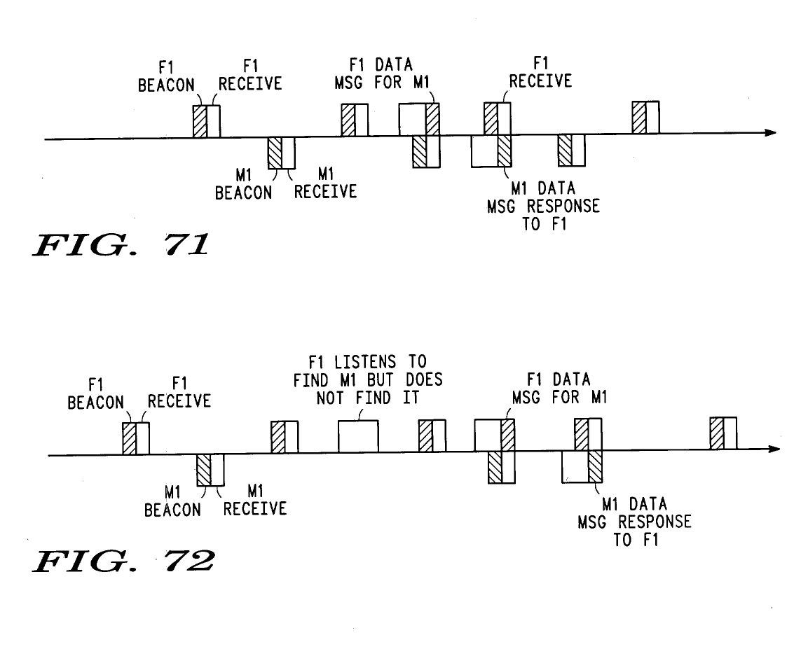

The above communication protocol for networks having the ability to integrated MNs in their operations, necessarily means that the MNs must be in communication with their associated connecting nodes. FIGS. 71-74 illustrate various embodiments of how this might occur; in these figures, the communication periods of the fixed, connecting “F1” node are illustrated above the time line and the communication periods of the MN, the “M1” node, are illustrated below the time line.

M1 can transmit a beacon periodically when it is awake. Such a beacon may be at the same frequency as the connecting node of the MN, or the beacon of the MN may transmit not as often as its connecting node. Referring now to FIG. 71, a time line in which the M1 MN transmits a beacon at the same rate as its connection node F1 is illustrated. This approach allows M1 to synch up with F1 very easily to receive the data F1 has for it and immediately send a confirmation message back. In FIG. 72, MN M1 transmits a beacon but at a reduced rate as compared with connected node F1. F1 listens to find M1 but cannot immediately find it. It will repeat until the next frame up to “x” times, with x being the factor by which M1 has reduced its beacon frequency relative to F1's beacon frequency. In the example shown in the figure, F1 is able to hear M1 the next communication period and thus synch up for data transfer to M1. This approach utilizes less of M1's battery reserves since it beacons less often, but it may take longer for communication between F1 and M1 to occur.

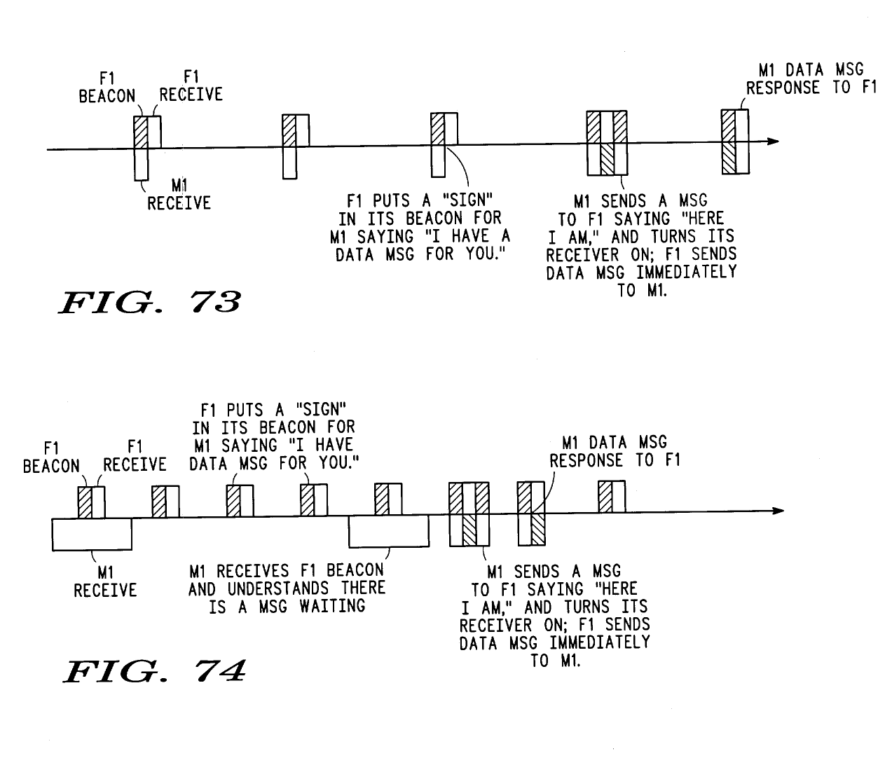

Referring now to FIG. 73, an example in which the mobile node M1 does not beacon but is operable to receive data at the same rate as the connecting node F1 is shown. During the third communication transmission period of F1, it can be seen that F1 puts a message in its beacon for M1 to let it know that it has a message for M1. In the fourth communication period, common to both M1 and F1 since they communicate at the same data rate, M1 responds by sending a message to let F1 know it is ready to receive data, thereby allowing F1 to immediately send the data message to M1. In the next cycle, M1 communicates receipt of the data to F1. It is noted that the window receive length during which M1 can receive could be much longer but without benefit. If the M1 receive window is smaller than the full frame length, as shown in the example, then the M1 receive window must be synchronized with the F1 beacon, as shown.

Finally, as shown in FIG. 74, the mobile node M1 may not transmit a beacon signal but receive data at a reduced rate of the connecting node's rate. It can be seen that in this circumstance, it is necessary for M1 to receive for the duration of the full frame of F1. F1 communicates via its beacon that it has a message for M1, which is subsequently received and understood by M1. M1 sends a message to let F1 know it is ready to receive a message and immediately does so. A subsequent data acknowledgement message is sent to F1.

In the cases where the MN does not have a beacon but can just listen for messages for it on the network, it has been shown that it may be configured to listed all the time or wake up every so often to listen. In this mode, there is no beacon, which operates to conserve battery life of the MN.

Multicasting and other Communications in Networks with Mobile Nodes

The use of special addressing of MNs and corresponding proxy connecting nodes of the present invention furthermore provides for a variety of communication modes to be used in networks having MNs. Since a mobile node is not a part of the logical routing backbone of the spanning tree of a hierarchical network and since it accordingly does not participate in the routing of messages within the network, it is able to send and receive messages by use of a proxy messaging via a connecting node that connects the MN to the logical network as described above. The type of messaging can be unicast, broadcast or multicast as will be described.

Whereas the use of static addressing to allow proxy messaging to MNs has been described, this is not required. Indeed, it is possible to have logical addresses assigned to both regular, fixed nodes and MNs as they join the network but in a manner that still distinguishes the MNs from other, non-MN nodes. In a certain embodiment of the invention, both fixed nodes and MNs are assigned logical addresses when they join the network, although in a manner that distinguishes them as to type. For instance, the logical address space may be split into at least two distinct pools, one for fixed, non-MN devices and the other for MN nodes. In this way, the fixed and MN devices are still distinguished by their logical addressing and various types of addressing to both fixed and MN devices is facilitated, as will be described. In accordance with another embodiment, the MNs may still retain their physical MAC addresses after they join the network, as outlined at length above. In either approach, MN and fixed devices are distinguished within the network by the address or by their mode of addressing, as the case may be.

Knowledge of the addresses of the fixed and MN nodes of the network, often resident with a network coordinator node or other appropriate gateway node, is used to permit a variety of communication types, including direct or unicast communications between MN and non-MN devices, discussed above; multicast or point-to-multipoint communications, in which a source communication device or node wishes to send a message or other communication to multiple destination devices (and in which either the source or destination nodes, or both, may be MNs); and broadcast communications in which a source communication device or node wishes to send a message or communication to every device within range (the originator and/or one or more of the recipients may be MNs). In the case of any of these communication types, the message will be routed to all targeted fixed devices and to all connecting nodes associated with targeted MNs connected to them. If the originator (source) of the message does not have access to the database (managed by a control node) identifying the target MN and its associated connecting node, it will route the message to the device (control node) mostly like to have access to the database. The device receiving the message, such as the control node, will then be responsible for delivering the message to all the “proxy” fixed devices, serving as connecting nodes to the target MNs.

In another embodiment of the invention a multicast message is sent to a subset of one node/device type only, such as only to a subset of MNs or a subset of fixed nodes. The message may contain the unique address portion of the target address designating the targeted node(s) as being either mobile or fixed. Upon reception of the message, a fixed device only has to decipher portion of the address. At that point, the fixed device can discontinue reading the packet and instead relay the message if it is not the intended recipient. Because the hierarchical structure of the network allows routing by address as a default routing mechanism, the message will be relayed unicast throughout the spanning tree backbone of the network to the intended recipients. Alternately, in the case of a message meant for one or more MNs, the message can be relayed using another established wireless table routing scheme, such as Ad Hoc On Demand Vector Routing (AODV), Dynamic Source Routing (DSR), etc. In either approach, the routing strategies reduce the number of messages exchanged by routing the multicast message packet more efficiently to its final operation. This is preferable to flooding the multicast information throughout the entire network.

In accordance with yet another embodiment that takes advantage of the ability of MNs to change their physical location relatively frequently, a fixed node acting as a connecting node to a MN attached to it can use the MN to send a multicast message to a subset of fixed nodes located remotely from the fixed node. The fixed node can cause the MN to deploy to the remote location and once in position, cause the MN to broadcast a packet to the intended recipients. This may be repeated for various geographical parts of the network. The geographical information about the network needed by the fixed connecting node, and its MN, for this approach may be provided by a control node of the network to the fixed node.

In the above approaches, a device's network address field may be a filtering mechanism to enable routing schemes for various communication types in a manner that reduces the network flooding often associated with traditional multicast messages. Moreover, the repositioning ability of MNs is leveraged to extend communication beyond the communication range of an individual fixed device to other parts of the network. This may be handy in potentially many situations, including the ability for a fixed node in possession of information critical to a remote location, such as emergency, maintenance or control information, to cause one or more MNs with which it is in communication to re-deploy to that remote location and then broadcast the information there. In a similar manner, highly secure information can be delivered to specific targeted devices in a way that minimizes the chance of “over the air transport” eavesdropping and interception that may occur during multihop communication. Furthermore, using a MN to envoy a message to a geography of the network sufficiently distant from the fixed device can eliminate the transmission of intervening multihop transmissions that would otherwise be required, an obvious energy savings on the power sources of the intervening devices or nodes. And, of course, reducing the number of hops required to get a message to its intended target may also provide the additional benefit of reduced message interference by reducing the number of message re-transmissions along the path.

There are benefits of this protocol that may be substantial with regards to network control and node battery life. This approach simplifies the manner in which networks having the ability to have MNs maintain and manage themselves. When a MN changes its location in the physical network, the logical network does not have to delete or change the node's address and no reconfiguration of the logical network is required. In fact, the status of a MN relative to the network does not change, other than needing to acquire a new connecting node. The protocol reduces computational and control message-forwarding demands that might otherwise be experienced by MN movement. This, in turn, means less consumption of scarce and precious battery resources.

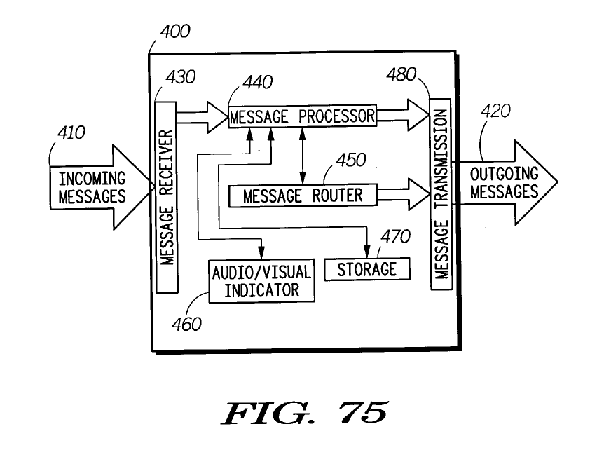

Referring to FIG. 75, a functional block diagram 400 of the internal operation of a node operable for the network of the present invention is shown. The basic functionality received in receiver 430, processor 440, router 450, storage 470, and transmitter 480 of the diagram are applicable to the various types of nodes, including MNs, NN, CH, gateway nodes, and network coordinator nodes, of the network, with variations in control and processing functionality, outlined above, being incorporated. Incoming messages 410 are first received by message receiver 430, which then prepares the incoming messages 410 for processing by message processor 440. Message processor 440 interacts with storage block 470, audio/visual indicator 460, and message router 450 in order to correctly process incoming messages 410. Node 400 also contains message transmission 480 (receiver) capability that allows nodes 400 to prepare outgoing messages 420 created by either message router 450 or message processor 440. The outgoing messages 420 could include status messages, routed data messages, messages to nodes within communication range of nodes 400, or any similar type of message traffic, again depending upon the type of node at issue. Referring again to FIG. 75, note that while the functionality shown has been placed in separate blocks, the internal blocks shown could be further separated or combined in functionality without departing from the spirit and scope of the present invention.

Those of ordinary skill in the art will recognize that the present invention has been described in terms of exemplary embodiments based upon use of a particular message set. However, the invention should not be so limited, since the present invention could be implemented functionally equivalent messages.

The nodes themselves may comprise a variety of hardware components including as special purpose hardware and/or dedicated processors. Similarly, general purpose computers, microprocessor based computers, digital signal processors, microcontrollers, dedicated processors, custom circuits, ASICS and/or dedicated hard wired logic may be used to construct alternative equivalent embodiments of the present invention.

Each node is directed by a computer program. Those ordinarily skilled in the art will appreciate that the program steps and associated data used to implement the embodiments described above can be implemented using disc storage as well as other forms of storage, such as, for example, Read Only Memory (ROM) devices, Random Access Memory (RAM) devices, optical storage elements, magnetic storage elements, magneto-optical storage elements, flash memory, core memory and/or other equivalent storage technologies without departing from the present invention. Such alternative storage devices should be considered equivalents.

While the invention has been described in conjunction with specific embodiments, it is evident that many alternatives, modifications, permutations and variations will become apparent to those of ordinary skill in the art in light of the foregoing description. Accordingly, it is intended that the present invention embrace all such alternatives, modifications and variations as fall within the scope of the appended claims.

What is claimed is:

1. A method of self-organization of a network comprising a plurality of nodes, at least one of said plurality of nodes operable as a control node of the network, said method comprising:
a mobile node transmitting a connection request to a node of the plurality of nodes to request the node operate as a connecting node of the mobile node to the network;
if the node agrees to be the connecting node of the mobile node, the mobile node connecting to the node and the node operating as the connecting node of the mobile node to the network;
the node communicating its status as the connecting node of the mobile node to the control node of the network; and
the control node updating the network to reflect the node as the connecting node of the mobile node in the network.

2. The method of claim 1, further comprising the mobile node selecting the node based upon one or more selection criteria.

3. The method of claim 1, further comprising:
the control node routing messages intended for the mobile node to a logical address of the node; and
the node forwarding on to the mobile node the messages intended for the mobile node.

4. The method of claim 1, wherein updating the network to reflect the node as the connecting node of the mobile node further comprises:
associating the mobile node with the node so that messages intended for the mobile node are routed by the control node to the node.

5. The method of claim 1, further comprising:
the mobile node disassociating from the network upon the occurrence of a disassociation event.

6. The method of claim 5, further comprising prior to disassociating from the network, the mobile node sending the node a disassociation message.

7. The method of claim 6, wherein the node communicates the disassociation message to the control node and the control node updates information about the mobile node.

8. The method of claim 1, wherein after the occurrence of a disassociation event, further comprising:
the mobile node transmitting a reassociation connection request to a second node of the plurality of nodes of the network to request the second node operate as the connecting node of the mobile node to the network;
if the second node agrees to be the connecting node of the mobile node, the mobile node connecting to the second node and the second node operating as the connecting node of the mobile node to the network;
the second node communicating its status as the connecting node of the mobile node to the control node of the network; and
the control node updating the network to reflect the second node as the connecting node of the mobile node in the network.

9. The method of claim 8, further comprising the mobile node selecting the node based upon one or more selection criteria.

10. The method of claim 8, wherein the second node is the same as the node of the network and a geographical position of the mobile node has not changed.

11. The method of claim 8, wherein a geographical position of the mobile node has changed prior to the mobile node transmitting the reassociation connection request.

12. The method of claim 1, further comprising:
the node causing the mobile node to deploy to a geographical location of the network; and
the node causing the mobile node to transmit a multicast message to a subset of nodes of the plurality of nodes of the network, wherein the subset of nodes are within communication range of the mobile node at the geographical location.

13. The method of claim 1, further comprising:
assigning a static address to the mobile node.

14. The method of claim 13, further comprising:
the control node routing messages intended for the mobile node to a logical address of the node, wherein the messages contain the static address of the mobile node; and
the node forwarding on to the static address of the mobile node the messages intended for the mobile node.

15. The method of claim 13, wherein updating the network to reflect the node as the connecting node of the mobile node further comprises:
associating the static address of the mobile node with the node.

16. The method of claim 15, further comprising:
transmitting messages intended for the mobile node to a logical address of the node; and
the node transmitting the messages intended for the mobile node to the static address of the mobile node.

17. The method of claim 13, wherein the static address is a mobile node static address and further comprising:
the mobile node transmitting the mobile node static address to the node in the connection request; and
the node transmitting the mobile node static address to the control node when communicating its status as the connecting node of the mobile node.

18. The method of claim 17, wherein the mobile node static address is inherent to the mobile node and does not change.

19. The method of claim 17, wherein the mobile node static address is a MAC address of the mobile node.

20. The method of claim 17, further comprising:
transmitting messages intended for the mobile node to a logical address of the node;
the node transmitting the messages intended for the mobile node to the mobile node static address of the mobile node.

21. The method of claim 17, further comprising:
the mobile node disassociating from the network upon the occurrence of a disassociation event; and
the mobile node keeping the mobile node static address upon disassociating from the network.

22. The method of claim 21, further comprising prior to disassociating from the network, the mobile node sending the node a disassociation message.

23. The method of claim 22, wherein the node communicates the disassociation message to the control node and the control node updates information about the mobile node.

24. The method of claim 17, further comprising after the occurrence of a disassociation event:
the mobile node transmitting a reassociation connection request to a second node of the plurality of nodes of the network to request the second node operate as the connecting node of the mobile node to the network, wherein the reassociation connection request contains the mobile node static address of the mobile node;
if the second node agrees to be the connecting node of the mobile node, the mobile node connecting to the second node and the second node operating as the connecting node of the mobile node to the network;
the second node communicating its status as the connecting node of the mobile node and the mobile node static address to the control node of the network; and
the control node updating the network to reflect the second node as the connecting node of the mobile node in the network.

25. The method of claim 13, wherein the static address is a network static address and further comprising:
after the node communicates its status as the connecting node of the mobile node to the control node, the control node assigning the network static address to the mobile node and communicating the network static address to the node.

26. The method of claim 25, wherein the node further assigns the network static address to the mobile node.

27. The method of claim 25, further comprising:
transmitting messages intended for the mobile node to a logical address of the node;
the node transmitting the messages intended for the mobile node to the network static address assigned to the mobile node.

28. The method of claim 25, wherein the control node assigns the network static address to the mobile node from a plurality of network static addresses of the network available to mobile nodes joining the network.

29. The method of claim 25, wherein the control node randomly chooses the network static address assigned to the mobile node.

30. The method of claim 25, further comprising:
the mobile node disassociating from the network upon the occurrence of a disassociation event; and
the mobile node relinquishing to the network the network static address upon occurrence of the disassociating event.

31. The method of claim 30, further comprising prior to disassociating from the network, the mobile node sending the node a disassociation message in which the mobile node relinquishes the network static address.

32. The method of claim 31, wherein the node communicates the disassociation message to the control node and the control node updates information about the mobile node.

33. The method of claim 1, further comprising:
the mobile node communicating to the node in the connection request a connection status of the mobile node.

34. The method of claim 33, wherein the connection status of the mobile node is one of the mobile node re-associating with the network and the mobile node never having associated with the network.

35. The method of claim 1, further comprising:
the mobile node requesting information from the node in the connection request and using information provided by the node in response to determine whether to request the node operate as the connecting node for the mobile node.

36. The method of claim 1, in communications between the mobile node and the node, further comprising:
the mobile node periodically transmitting a mobile node beacon during a communication period of the mobile node.

37. The method of claim 36, wherein the mobile node transmits the mobile node beacon at frequency that the node transmits a node beacon.

38. The method of claim 36, wherein the mobile node transmits the mobile node beacon at a reduced frequency compared to a frequency at which the node transmits a node beacon.

39. The method of claim 1, in communications between the mobile node and the node, further comprising:
the mobile node operable to periodically receive transmissions during a communication period of the mobile node.

40. The method of claim 39, wherein the mobile node is operable to periodically receive transmissions at a frequency at which the node is operable to receive transmissions.

41. The method of claim 39, wherein the mobile node is operable to periodically receive transmissions at a reduced frequency compared to a frequency at which the node is operable to receive transmissions.

42. The method of claim 1, further comprising:
transmitting a message intended for the mobile node to an address of the node serving as the connecting node for the mobile node;
the connecting node transmitting the message to an address of the mobile node.

43. The method of claim 42, wherein the message is a multicast message intended for the mobile node and a plurality of target nodes of the plurality of nodes.

44. The method of claim 1, further comprising:
the mobile node initially routing messages intended for one or more nodes of the plurality of nodes to the connecting node.

45. The method of claim 1, further comprising:
assigning an address to the mobile node, wherein a portion of the address of the mobile node indicates that the mobile node is part of a plurality of mobile nodes of the network;
transmitting a multicast message intended for the plurality of mobile nodes;
upon receiving the multicast message, the node deciphering the portion of the address; and
the node transmitting the message to the mobile node.

46. The method of claim 45, wherein the address of the mobile node and the address of the node are logical addresses of the network.

47. The method of claim 45, wherein the node transmitting the message to the address of the mobile node using a wireless routing protocol.

48. Computer-readable media tangibly embodying a program of instructions executable by a computer to implement a method of self-organization of a network comprising a plurality of nodes, at least one of said plurality of nodes operable as a control node of the network, said method comprising:
a mobile node transmitting a connection request to a node of the plurality of nodes to request the node operate as a connecting node of the mobile node to the network;
if the node agrees to be the connecting node of the mobile node, the mobile node connecting to the node and the node operating as the connecting node of the mobile node to the network;
the node communicating its status as the connecting node of the mobile node to the control node of the network; and
the control node updating the network to reflect the node as the connecting node of the mobile node in the network.

49. The method of claim 48, further comprising:
the control node routing messages intended for the mobile node to a logical address of the node; and
the node forwarding on to the mobile node the messages intended for the mobile node.

50. The method of claim 48, further comprising:
the mobile node sending the node a disassociation message upon the occurrence of a disassociation event to disassociate from the network;
the node communicating the disassociation message to the control node; and
the control node updating information about the mobile node in the network.

51. The method of claim 48, wherein after the occurrence of a disassociation event, further comprising:
the mobile node transmitting a reassociation connection request to a second node of the plurality of nodes of the network to request the second node operate as the connecting node of the mobile node to the network;
if the second node agrees to be the connecting node of the mobile node, the mobile node connecting to the second node and the second node operating as the connecting node of the mobile node to the network;
the second node communicating its status as the connecting node of the mobile node to the control node of the network; and
the control node updating the network to reflect the second node as the connecting node of the mobile node in the network.

52. The method of claim 48, further comprising:
the node causing the mobile node to deploy to a geographical location of the network; and
the node causing the mobile node to transmit a multicast message to a subset of nodes of the plurality of nodes of the network, wherein the subset of nodes are within communication range of the mobile node at the geographical location.

53. The method of claim 48, further comprising:
assigning a static address to the mobile node.

54. The method of claim 53, further comprising:
the control node routing messages intended for the mobile node to a logical address of the node; and
the node forwarding on to the static address of the mobile node the messages intended for the mobile node.

55. The method of claim 53, wherein the static address is a mobile node static address and further comprising:
the mobile node transmitting the mobile node static address to the node in the connection request; and
the node transmitting the mobile node static address to the control node when communicating its status as the connecting node of the mobile node.

56. The method of claim 55, further comprising:
transmitting messages intended for the mobile node to a logical address of the node;
the node transmitting the messages intended for the mobile node to the mobile node static address of the mobile node.

57. The method of claim 55, further comprising:
the mobile node disassociating from the network upon the occurrence of a disassociation event; and
the mobile node keeping the mobile node static address upon disassociating from the network.

58. The method of claim 55, further comprising after the occurrence of a disassociation event:
the mobile node transmitting a reassociation connection request to a second node of the plurality of nodes of the network to request the second node operate as the connecting node of the mobile node to the network, wherein the reassociation connection request contains the mobile node static address of the mobile node;
if the second node agrees to be the connecting node of the mobile node, the mobile node connecting to the second node and the second node operating as the connecting node of the mobile node to the network;
the second node communicating its status as the connecting node of the mobile node and the mobile node static address to the control node of the network; and
the control node updating the network to reflect the second node as the connecting node of the mobile node in the network.

59. The method of claim 53, wherein the static address is a network static address and further comprising:
after the node communicates its status as the connecting node of the mobile node to the control node, one of the control node and the node assigning the network static address to the mobile node.

60. The method of claim 59, further comprising:
the mobile node disassociating from the network upon the occurrence of a disassociation event; and
the mobile node relinquishing to the network the network static address upon occurrence of the disassociating event.

61. The method of claim 48, in communications between the mobile node and the node, further comprising:
the mobile node periodically transmitting a mobile node beacon during a communication period of the mobile node.

62. The method of claim 48, further comprising:
assigning an address to the mobile node, wherein a portion of the address of the mobile node indicates that the mobile node is part of a plurality of mobile nodes of the network;
transmitting a multicast message intended for the plurality of mobile nodes;
upon receiving the multicast message, the node deciphering the portion of the address; and
the node transmitting the message to the mobile node.

63. A mobile node device operable to become associated with a self-organizing network comprising a plurality of nodes, at least of which is operable as a control node of the network, said device comprising:
a processing and control element;
a receiver, coupled to and controlled by the processing and control element; and
a transmitter, coupled to and controlled by the processing and control element,
wherein if the mobile node device wishes to associate with the network the processing and control element causes the transmitter to transmit a connection request to a node of the plurality of nodes to request that the node to serve as a connecting node for the mobile node device to the network and wherein the receiver is operable to receive an acceptance message from the node if the node accepts to be the connecting node for the mobile node device.

64. The device of claim 63, wherein a static address of the mobile node device is transmitted in the connection request by the transmitter.

65. The device of claim 64, wherein the static address is a mobile node static address inherent to the mobile node device that does not change.

66. The device of claim 63, wherein the receiver is operable to receive messages intended for the mobile node device from the node operating as the connecting node.

67. The device of claim 63, wherein upon the occurrence of a disassociation event, the processing and control element causes the mobile node device to disassociate from the network.

68. The device of claim 67, wherein upon occurrence of the disassociation event, the processing and control element causes the transmitter to transmit a disassociation message to the node prior to disassociating from the network.

69. The device of 63, the processing and control element causes the transmitter to transmitter a reassociation connection request to a second node of the plurality of nodes of the network to request the second node serve as the connecting node of the mobile node device.

70. The device of claim 69, the processing and control element further causing the transmitter to transmit a static address of the mobile node device in the reassociation connection request.

71. The device of claim 63, wherein in response to the receiver receiving instruction from the node to deploy to a new geographical location of the network, the processing and control element causing the mobile node device to deploy to the new geographical location.

72. The device of claim 71, wherein in response to the receiver receiving instruction from the node, the processing and control element causing the transmitter to transmit a multicast message to a subset of nodes of the plurality of nodes that are in communication range of the mobile node device in the new geographical location.

73. The device of claim 63, wherein the processing and control element causes the transmitter to periodically transmit a mobile node beacon during a communication period of the mobile node device.

74. A self-organizing asynchronous communications network, comprising:
a plurality of nodes;
a control node within communication range of one or more of the plurality of nodes; and
a mobile node within communication range of one or more of the plurality of nodes,
wherein upon a connection request from the mobile node to a node of the plurality of nodes, the node is operable to serve as a connecting node for the mobile node to the network and communicate its status as the connecting node to the control node and wherein the control node updates the network to route messages intended for the mobile node to the node for delivery to the mobile node by the node.

75. The network of claim 74, wherein the control node routes messages intended for the mobile node to a logical address of the node and the node routes the messages to a static address of the mobile node.

76. The network of claim 75, wherein upon the occurrence of a disassociation event, the mobile node disassociates from the network.

77. The network of claim 76, wherein prior to disassociating from the network, the mobile node transmits a disassociation to the node and the node communicates the mobile node's disassociation from the network to the control node.

78. The network of claim 76, wherein after disassociating from the network the mobile node transmits a reassociation connection request to a second node to request the second node to operate as the connecting node of the mobile node and if the second node accepts the request the second node becomes the connecting node.

79. The network of claim 78, wherein upon becoming the connecting node, the second node communicates its status to the control node and the control node updates the network to route messages intended for the mobile node to the second node.

80. The network of claim 74, wherein the mobile node selects the node to serve as the connecting node based upon one or more selection criteria.

81. The network of claim 74, wherein the node causes the mobile node to deploy to a new geographical location with respect to the network and then transmit a multicast message to a subset of nodes of the plurality of nodes within communication range of the mobile node at the new geographical location.

82. The network of claim 74, wherein the mobile node has a static address used to route messages to the mobile node via the connecting node.

83. The network of claim 82, wherein the static address is a mobile node static address inherent to the mobile node that does not change.

84. The network of claim 83, wherein the mobile node static address does not change even upon disassociation of the mobile node from the network.

85. The network of claim 84, wherein to reassociate with the network the mobile node transmits a reassociation connection request to a second node of the plurality of nodes to request the second node operate as the connecting node of the mobile node, wherein the reassociation connection request contains the mobile node static address of the mobile node,
and wherein upon the second node agreeing to be the connecting node and communicating its status as connecting node to the control node, the mobile node has reassociated with the network and messages intended for the mobile node will be sent in care of the second node.

86. The network of claim 74, wherein the mobile node is operable to transmit a mobile node beacon at a frequency determined by the frequency at which the node transmits a node beacon.
